(19) United States
(12) Patent Application Publication
(10) Pub. No.: US 2021/0002835 A1
(43) Pub. Date: Jan. 7, 2021

(54) Traffic Control, Site Observation, and Data Management System and Apparatus Including a Remotely-Controllable Arm

(71) Applicant: RSA Protective Technologies, LLC, Claremont, CA (US)

(72) Inventors: Richard S. Adler, Claremont, CA (US); George Doland, Houston, TX (US); Risto Salo, Valencia, CA (US)

(73) Assignee: RSA Protective Technologies, LLC, Claremont, CA (US)

(21) Appl. No.: 16/874,667

(22) Filed: May 14, 2020

Related U.S. Application Data
(60) Provisional application No. 62/920,846, filed on May 17, 2019.

(51) Int. Cl. E01F 13/06; E01F 13/02; E01F 9/615; E01F 9/30; G08G 1/0955; H04N 7/18; H04W 4/48; H02J 7/00; H05B 47/175; F21L 4/08

(52) U.S. Cl. CPC E01F 13/06; E01F 13/02; E01F 9/615; E01F 9/30; F21L 4/08; H04N 7/181; H04W 4/48; H02J 7/0048; H05B 47/175; G08G 1/0955

(57) ABSTRACT

A trailer-mounted system and apparatus are provided to improve safety at road construction sites and other locations by allowing drivers to be signaled, and one or more lanes of traffic blocked, without having a flagger stand in or immediately adjacent to a road that is carrying traffic. The system and apparatus may have extensive data and audio and video networking capabilities to allow for remote control of the system and/or observation of the construction site. These networking capabilities may allow the system to further serve to enhance collaboration among remote worksites.

A variant apparatus may be mounted on a highway divider such as a K-rail instead of a mobile trailer. Another variant provides a portable kiosk containing apparatus to supply the data networking and collaboration functions without the mechanical apparatus used to block traffic.

### CROSS-REFERENCE TO RELATED APPLICATION

This application claims the benefit of provisional U.S. patent application No. 62/920,846, filed on 17 May 2019 and titled “Smart Arm traffic warning lighted beam moving horizontally into traffic to stop and control traffic flow with multiple cameras and communications to have Smart Arm and video, voice, data and text transferred between unit at site and remote locations. Trailer version, K-rail version and monument mounted configuration”, which is fully incorporated into this disclosure by reference.

### BACKGROUND

Road construction and other conditions (e.g., flooding) may temporarily limit vehicular traffic in some or all lanes of a roadway. A flagger directing traffic is a familiar sight in such circumstances, but it presents safety hazards. Sometimes, despite regulations and/or work rules, a flagger risks serious injury by standing in the roadway as traffic goes by. And a flagger may be only marginally safer standing immediately adjacent to an active roadway while signaling drivers.

There is also a need for ongoing observation of the status of a construction zone. Moreover, a road construction site is a workplace, and like many workplaces, it presents needs for communication among people and devices, both on-site and remotely.

There is therefore a need for both a safer way to control traffic in areas of temporary obstruction and improved infrastructure to observe the sites and to support workers in those areas.

### BRIEF SUMMARY OF THE INVENTION

Embodiments of a road closure and site support system may provide a physical means to close off a road or portion of the road using an automated swing arm gate. The swing arm and associated mechanisms and controls may in embodiments of the invention be mounted, e.g., to a small mobile trailer. During operation, the arm may swing 90 degrees from an open position parallel to the roadway to a closed position across the traffic lane.

In embodiments of the invention, the arm contains multiple patterns of high intensity LED lighting units. In exemplary embodiments of the invention, each lighting unit may be approximately 2×6 inches in various colors to display a variety of patterns as needed. In some embodiments of the invention, the beam also may also include, e.g., a separate flashing Stop or Slow sign (or other kinds of sign) for further instruction and visibility. This selectable information feature can be used, e.g., to provide safety routing instructions in a large variety of applications, from construction to flooding, and including roadway emergencies.

In embodiments of the invention, the mechanisms that control the arm and the patterns of display of the lights may be controlled, e.g., by a control panel and/or human-machine interface (HMI) connected to a programmable logic controller (PLC), which may actually operate the arm and/or lights as programmed. The PLC may further interoperate with one or more other computing, communications, and/or storage devices in performing its functions. (The PLC, in conjunction with some or all other computing, communications, and/or storage devices, may be referred to collectively in this disclosure as a “programmable control system”.)

Embodiments of the invention may comprise devices supporting wired and/or wireless data networking, which may interoperate with the PLC and/or other devices. With the provision of data networking, embodiments of the invention may provide both LAN and WAN connectivity to the PLC and/or other control systems. Such networking may in embodiments of the invention enable, e.g., remote observation and/or control of the apparatus and/or site.

Power in embodiments of the invention may be provided, e.g., by one or more large-capacity storage batteries. Further, embodiments of the invention may include, e.g., a generator and fuel storage to recharge the batteries as necessary. Alternative sources of power in connection with embodiments of the invention may include, e.g., solar panels, wind turbines, and other forms of renewable energy.

Embodiments of the invention may comprise an apparatus configured for traffic control that need not be mounted on a trailer. For example, an apparatus according to embodiments of the invention may be include, e.g., a saddle permitting the apparatus to be mounted on a highway barrier (e.g., a K-rail, also known as a Jersey barrier) or other structure.

Embodiments of the invention may include devices and an independent power supply to create, e.g., a portable voice and data networking and communications hub. According to embodiments of the invention, devices enabling these functions may be placed, e.g., in a standalone enclosure without a swing arm or associated mechanical component.

According to embodiments of the invention, a trailer-mounted apparatus for controlling the flow of traffic comprises a trailer and a movable horizontal swing arm. The arm is supported by and actuated by an electrically-powered mechanism affixed to the trailer. The arm is configured to have a closed position, in which it obstructs the flow of traffic in at least one traffic lane adjacent to the trailer, and an open position in which it permits the free flow of traffic in the at least one lane. The apparatus further comprises a control position comprising at least one control panel for use by an operator to control the arm and a power supply configured to provide electric power to the control position and the electrically-powered mechanism.

According to an embodiment of the invention, the apparatus comprises a programmable control system and a vertical mast, where the mast supports a mast component enclosure. In the embodiment, the programmable control system is operatively coupled to the control panel, the mast component enclosure contains at least one set of electrically operable lights and a networking device supporting one or more wireless data networks, the electrically operable lights and the networking device are operatively connected to the programmable control system, and the electrically operated lights and the networking device receive electrical power from the power supply.

According to an embodiment of the invention, the electrically operated lights comprise a series of white lights disposed on the underside of the mast component enclosure, e.g., to illuminate the apparatus at night. Further, according to an embodiment, the electrically operated lights comprise blinking blue and red lights disposed along all four sides of the mast control enclosure, e.g., at a height of 14 feet to alert drivers from a distance of a circumstance they should be aware of.

According to a further embodiment, the networking device provides one or more wired data networks usable at the apparatus.

According to a further embodiment, the apparatus comprises one or more video cameras operably coupled to the programmable control system. In one such embodiment, the control position includes at least one video display device allowing the operator to view video feeds produced by at least one of the cameras. In a further such embodiment, the apparatus comprises a data storage device, wherein: the programmable control system stores video from at least one of the cameras on the data storage device; the control position comprises at least one hardware interface operatively connected to the programmable control system, the hardware interface permitting operable connection of a removable storage device to the programmable control system; and the programmable control system is configured to permit downloading stored video to the data storage device.

Alternatively, in an embodiment of the invention, the apparatus comprises two cameras, each mast-mounted, which may be rotated, e.g., electronically through 360 degrees. The cameras may produce video feeds viewable at the control position and which may be stored in a storage device. According to a further embodiment of the invention, the programmable control system is configured at least to establish a data connection with a remote computer via the networking device, using one of the wireless data networks and, in response to a request from the remote computer, transfer stored video via the wireless data network to the remote computer.

In an alternative embodiment of the invention, the apparatus may comprise two parallel video systems, e.g., a first video system comprising first cameras and producing video data that may be stored locally and then downloaded, e.g., through a hardware interface incorporated into the apparatus, and a second video system comprising second cameras producing a video feed that may be streamed to one or more remote computers via a data network.

In an embodiment of the invention, the power supply comprises one or more rechargeable 12-volt batteries. In a further embodiment, the apparatus comprises a generator, wherein the generator is configured to recharge the batteries, and the programmable control system is programmed to detect a charge level of the batteries and to cause the generator to recharge the batteries upon determining that the charge level is below a predetermined threshold.

In an embodiment of the invention, the horizontal swing arm comprises a plurality of arrays of lights, the programmable control system is programmed to cause the lights in the arrays to operate according to a predetermined pattern in response to a command from an operator. In an embodiment, the programmable control system is configured at least to receive the command via the control panel. In an alternative embodiment, the programmable control system is configured at least to receive the command via a handheld remote control.

In embodiments of the invention, the handheld remote control may, e.g., permit an operator to safely remain in a service vehicle, just upstream of the arm, to see the pattern of lights produced by the swing arm. Further, in such an embodiment, the operator may remain, e.g., in a climate-controlled environment, such as the passenger compartment of a vehicle, out of the elements, and less vulnerable to being struck by a vehicle, e.g., at night or during other periods of poor visibility.

In another alternative embodiment, the programmable control system is configured at least to participate in the data network via the networking device and to receive the operator's command from a remote device via the data network.

In an embodiment of the invention, the programmable control system is configured at least to operate the arm in response to a command received from a remote control. In a further embodiment of the invention, the apparatus is configured at least to participate in the data network via the networking device and receive the command from a remote device via the data network.

According to embodiments of the invention, an apparatus for controlling the flow of traffic comprises a movable horizontal swing arm. The arm is supported by and actuated by an electrically-powered mechanism. The arm is configured to have a closed position, in which the horizontal swing arm obstructs the flow of traffic in at least one traffic lane adjacent to the apparatus, and an open position in which the horizontal swing arm permits the free flow of traffic in the at least one lane. The apparatus further comprises a control position comprising at least one control panel for use by an operator to control the arm and a power supply configured to provide electric power to the control position and the electrically-powered mechanism.

According to embodiments of the invention, the apparatus comprises a saddle attached to the electrically powered mechanism, the saddle being configured to secure the apparatus to a highway barrier for operation. According to an embodiment, the saddle is configured to rest stably atop the barrier and/or to be affixed to the highway barrier, e.g., by one or more straps or, alternatively, by permanently mounting the saddle with bolts driven into the highway barrier.

In an embodiment of the invention, the apparatus comprises a programmable control system and a vertical mast, the mast supporting a mast component enclosure. In the embodiment, the programmable control system is operatively coupled to the control panel, the mast component enclosure contains at least one set of electrically operable lights and a networking device supporting one or more wireless data networks, the electrically operable lights and the networking device are operatively connected to the programmable control system, and the electrically operated lights and the networking device receive electrical power from the power supply.

According to an embodiment of the invention, the electrically operated lights comprise a series of white lights disposed on the underside of the mast component enclosure, e.g., to illuminate the apparatus at night. Further, according to an embodiment, the electrically operated lights comprise blinking blue and red lights disposed along all four sides of the mast control enclosure, e.g., at a height of 14 feet to alert drivers from a distance of a circumstance they should be aware of.

In an further embodiment of the invention, the networking device provides one or more wired data networks usable at the apparatus.

In an embodiment of the invention, the apparatus comprises one or more video cameras operably coupled to the programmable control system. In a further embodiment, the control position includes at least one video display device allowing the operator to view the video feed produced by at least one of the cameras. In a further embodiment, the apparatus comprises a data storage device, and: the programmable control system stores video from at least one of the cameras on the data storage device, the control position comprises at least one hardware interface operatively connected to the programmable control system, the hardware interface permitting operable connection of a removable storage device to the programmable control system, and the programmable control system is configured to permit downloading stored video to the data storage device.

According to a further embodiment of the invention, the programmable control system is configured at least to establish a data connection with a remote computer via the networking device, using one of the wireless data networks, and, in response to a request from the remote computer, transfer stored video via the wireless data network to the remote computer.

According to an embodiment of the invention, the power supply comprises one or more rechargeable 12-volt batteries.

According to an embodiment of the invention, the horizontal swing arm comprises a plurality of arrays of lights, and the programmable control system is programmed to cause the lights in the arrays to operate according to a predetermined pattern in response to a command from an operator. According to a further embodiment of the invention, the programmable control system is configured at least to receive the command via the control panel. Alternatively, according to a further embodiment of the invention, the programmable control system is configured at least to receive the command via a handheld remote control.

In embodiments of the invention, the handheld remote control may, e.g., permit an operator to safely remain in a service vehicle, just upstream of the arm, to see the pattern of lights produced by the swing arm. Further, in such an embodiment, the operator may remain, e.g., in a climate-controlled environment, such as the passenger compartment of a vehicle, out of the elements, and less vulnerable to being struck by a vehicle, e.g., at night or during other periods of poor visibility.

Alternatively, according to a further embodiment of the invention, the programmable control system is configured at least to participate in the data network via the networking device and to receive the operator's command from a remote device via the data network.

In an embodiment of the invention, the programmable control system is configured at least to operate the arm in response to a command received from a remote control. Alternatively, in an embodiment of the invention, the programmable control system is configured at least to participate in the data network via the networking device and to receive the command from a remote device via the data network.

### BRIEF DESCRIPTION OF THE DRAWINGS

FIGS. 1-3 depict in three views a trailer-mounted system with a swing arm in closed position according to an embodiment of the invention.

FIGS. 4-6 depict in three views a trailer-mounted system, with a swing arm in open position, configured for transport or storage according to an embodiment of the invention.

FIGS. 7 and 8 depict in two views a portion of a trailer-mounted system according to an embodiment of the invention.

FIG. 9 depicts a mechanical assembly for moving a swing arm according to an embodiment of the invention.

FIG. 10 depicts in two views a main frame mount weldment according to an embodiment of the invention.

FIG. 11 depicts a mechanical assembly in exploded view according to an embodiment of the invention.

FIG. 12 depicts a pivot weldment for a swing arm according to an embodiment of the invention.

FIG. 13 depicts a latched pivot weldment according to an embodiment of the invention.

FIG. 14 depicts a telescoping swing arm according to an embodiment of the invention.

FIGS. 15 and 16 depict in two views a trailer-mounted system incorporating a folding arm according to embodiments of the invention.

FIGS. 17 and 18 depict in two views a trailer-mounted system incorporating a folding arm according to embodiments of the invention.

FIGS. 19 and 20 depict in two views a trailer-mounted system incorporating a folding arm according to embodiments of the invention.

FIG. 21 depicts in two views a mast component enclosure according to an embodiment of the invention.

FIG. 22 depicts a video camera assembly.

FIG. 23 depicts a trailer-mounted system incorporating alternative masts and cameras according to embodiments of the invention.

FIGS. 24 and 25 depict in two views a trailer-mounted system incorporating alternative masts and cameras according to embodiments of the invention.

FIG. 26 is a block diagram illustrating interconnections between components in an embodiment of the invention.

FIG. 27 depicts a control panel according to an embodiment of the invention.

FIGS. 28-30 depict patterns of illumination by lighting arrays according to an embodiment of the invention.

FIG. 31 depicts a display of soft controls as may be displayed by a HMI according to an embodiment of the invention.

FIGS. 32 and 33 depict in two views an apparatus mounted on a K-rail according to an embodiment of the invention.

FIGS. 34 and 35 depict in two views an apparatus mounted on a K-rail according to an embodiment of the invention.

FIG. 36 depicts a mobile office assembly in a usable configuration according to embodiments of the invention.

FIG. 37 depicts a mobile office assembly in an inactive configuration according to embodiments of the invention.

### DETAILED DESCRIPTION OF PREFERRED EMBODIMENTS

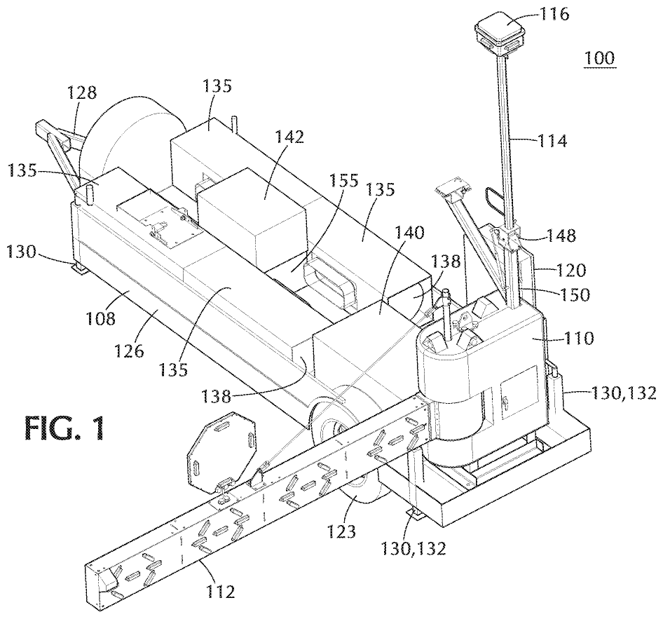

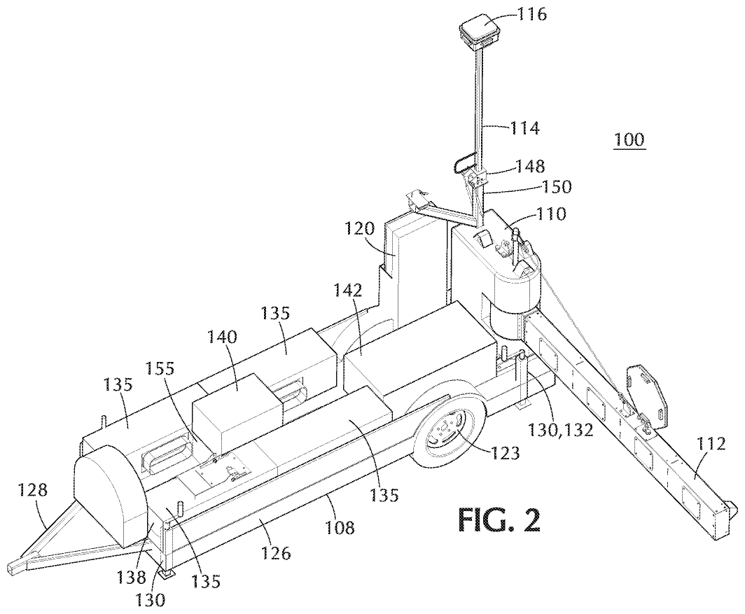

A road closure and site observation system 100 according to some embodiments of the invention may be regarded for some purposes as having four main components, e.g., as FIGS. 1-3 depict: a trailer 108; an arm/mast assembly 110 including a swing arm 112 and a mast 114, the mast 114 being topped by a mast component enclosure 116; a control and data processing system (which may be partly or wholly enclosed, e.g., by a control enclosure 120); and a power supply. This division is primarily conceptual, however, and it is meant to make the embodiments easier to grasp. It will be appreciated that, according to embodiments of the invention, features and functions described here in connection with one component may overlap with other components and be logically and physically distributed differently from how they are described here. Moreover, as will be disclosed more thoroughly, some of these components may be substantially or entirely omitted from some embodiments.

FIGS. 1-3 depict a trailer-mounted road closure and site support system 100 according to embodiments of the invention. In an embodiment of the invention such as FIGS. 1-3 depict, all assemblies may be mounted to a two-wheeled 123 trailer 108 for towing to the job site. In general, any trailer capable of safely and securely bearing the other components and configured to be towed by a motor vehicle may potentially be included in embodiments of the invention. Consistent with the intended on-road use, a trailer 108 may have, e.g., lights (not pictured) and any other features and attributes required by various motor vehicle licensing authorities.

Other considerations, however, may come into play in connection with some embodiments of the invention. For example, in connection with intended uses related to road construction, a trailer 108 may be built, e.g., with a nonstandard width, narrower than usual, to fit safely on narrow road shoulders.

For example, a trailer 108 according to one embodiment of the invention may be 4′ 6″ wide and 18′ 0″ long to the tongue, and it has a 41′ 0″×4′ 6″ wood platform. In the exemplary embodiment, the frame 126 of the trailer 108 is 5″ C-channel, which is completely seal welded. The axle (not pictured) may be, e.g., a 3000-lb. axle and equipped with shock absorbers (not pictured) to ensure a smooth and safe ride and to eliminate transfer of vibration to the electrical components.

The tongue 128 of the trailer may be equipped with any coupling means suitable for use with a towing vehicle, such as, e.g., a standard 2 5/16 ball coupler (not pictured). In embodiments of the invention, each corner of the trailer may be equipped with a drop leg stabilizer jack 130. As depicted, all stabilizer jacks may be along the edge of the frame, the rear stabilizer jacks 132 may in embodiments of the invention be extendable and act as outriggers. There may also be, e.g., a drop leg jack (not pictured) at the tongue 128 for support, e.g., during storage.

FIGS. 1-3 depict an arrangement of other structures on the trailer 108 according to an embodiment of the invention. As depicted, the trailer 108 includes four tank enclosures 135, each containing a tank 138. In embodiments of the invention, the tanks may hold, e.g., propane or other fuel to fuel a generator (not pictured), enclosed in a generator enclosure 142. The generator may be used to charge one or more batteries (not pictured), which may be contained in a battery enclosure 140.

As discussed further below, in an exemplary embodiment of the invention, power may be provided by a propane-fueled generator. Consistent with this example, this disclosure may at times refer, e.g., to “propane tanks” and a “propane generator” and use other related terms. This usage is illustrative, however, and not limiting, and it will be appreciated that other fuels, and structures and devices consistent with those fuels, may be used in embodiments of the invention instead of propane.

The various enclosures may be constructed of any desired material, although, considering typical operating conditions, it may be seen as desirable in connection with an embodiment of the invention to use a sufficiently strong and durable material to protect, e.g., against weather, vandalism, or both. Thus, for example, the exteriors of one or more of the generator cover 142 and the battery enclosure 140 may be built from sheet metal, such as galvanized steel. The tank enclosures 135 may similarly be built from sheet metal, or in embodiments in which the tanks 138 are deemed sufficiently durable and waterproof, the tank enclosures 135 may be formed, e.g., as metal cages to save weight and material and/or to ensure adequate ventilation. For example, according to an embodiment of the invention, each tank enclosure 135 may be a cage of 10-gauge steel.

In an embodiment of the invention, the control enclosure may be, e.g., a rated NEMA 4 waterproof box made from, e.g., fiberglass.

FIGS. 1-3 depict the mast 114 in a raised position. In embodiments of the invention, the mast may be articulated, e.g., with a manually operated hinge 148 atop a lower mast support 150, allowing the mast to be folded down for transport or storage.

According to embodiments of the invention, the ultimate height of the extended mast 114 may be, e.g., 14 feet. It will be appreciated that this height may be chosen in embodiments of the invention, e.g., to permit the trailer 108 to be towed with the mast 114 up while not interfering with 15-foot overpasses.

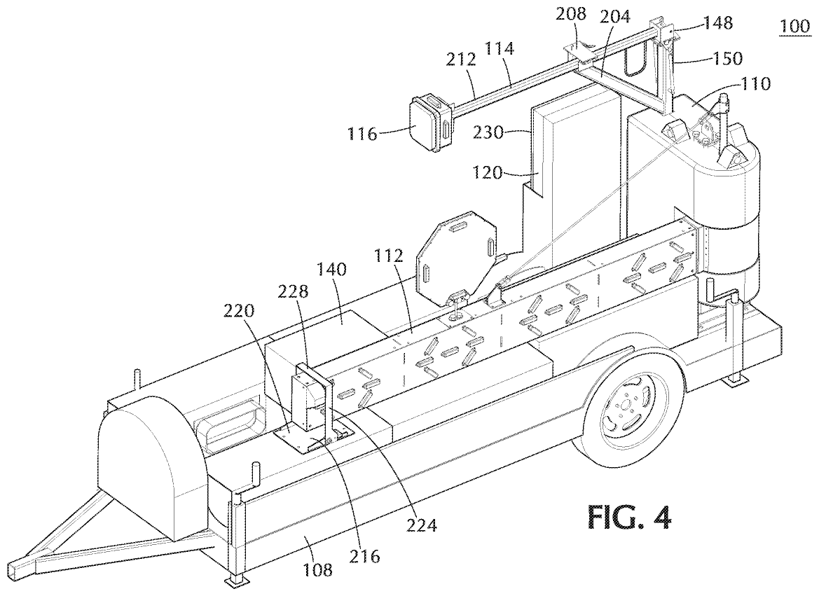

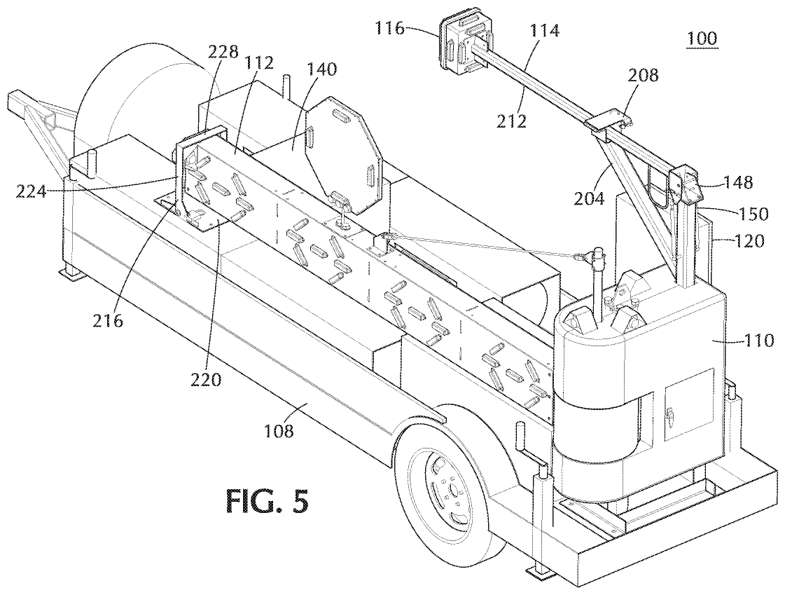

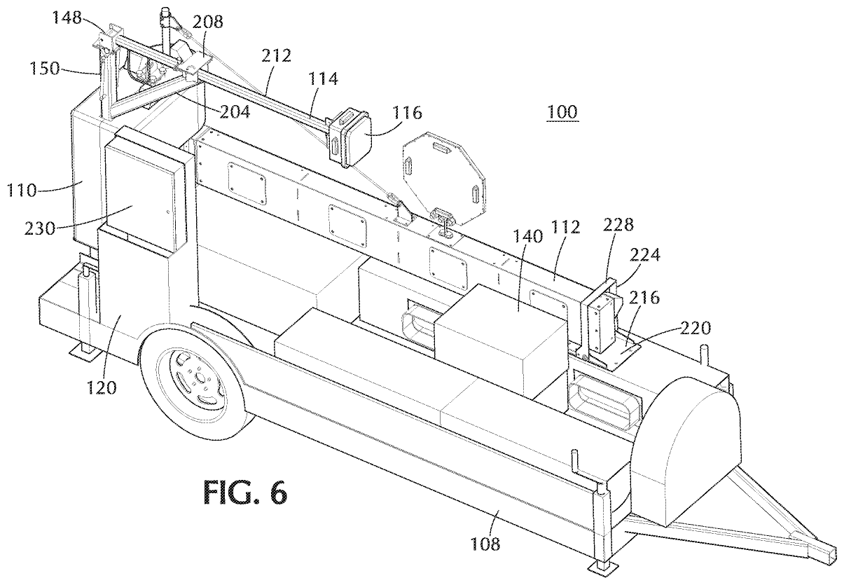

FIGS. 4-6 depict a trailer-mounted system 100 according to an embodiment of the invention with the mast folded in such a manner and the swing arm 112 in the open position. As depicted, an arm support 204 extends from the lower mast support 150 below the hinge 148, e.g., at an angle of 45 degrees from the mast. The arm 204 ends in a support 208 at roughly the same height above the trailer 108 as the hinge 148, such that when the upper half 212 of the mast 114 rests on the support, the upper half 212 is roughly parallel to the deck of the trailer 108.

The support 208 may be configured to retain the mast 114, e.g., during transport or storage. For example, as FIGS. 4-6 depict, the support 208 may be approximately U-shaped, e.g., to limit side-to-side motion of the mast 114. A retaining feature, e.g., a removable bolt or a sliding or hinged plate, may cover the top of the U, holding the mast in the support 208. In embodiments of the invention, the retaining feature may comprise, e.g., a latch, a lock, or holes for locking, to prevent unintentional release of the mast.

Similarly, in embodiments of the invention, an arm lock 216 may be provided to limit motion of the swing arm 112. For example, as FIGS. 4-6 depict, an arm lock 216 may comprise a base 220 affixed (e.g., bolted) to the top of one of the tank enclosures 135. A retainer 224 may be movably affixed to the base, e.g., so as to allow the retainer 224 to pivot between a vertical position (as FIGS. 4-6 depict), in which the vertical arms of the retainer 224 limit the side-to-side movement of the swing arm 112, and a horizontal position (not depicted), in which the retainer does not impede the motion of the swing arm 112. A plate 228 or other member may be affixable to the top of the retainer 224 in a manner that prevents a retainer 224 in the vertical position, holding the swing arm 112, from pivoting to the horizontal position. In embodiments of the invention, the arm lock 216 may comprise, e.g., a latch, a lock, or holes for locking (not pictured), to prevent unintentional release of the swing arm 112.

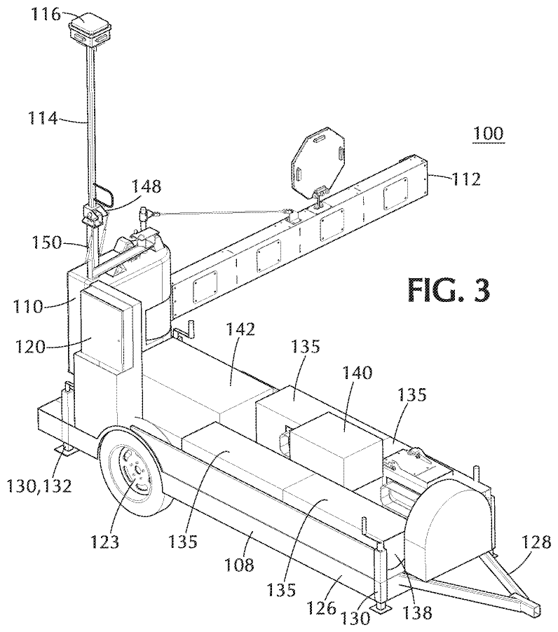

According to embodiments of the invention, traffic control may be achieved in part through the swing arm 112. FIG. 3 depicts an arm/mast assembly 110 comprising a swing arm 112 and a mast 114, mounted on a trailer 108, according to an embodiment of the invention. (For clarity, the control enclosure 120 and tank enclosures 135 and tanks 138 have been omitted from the drawing.)

As depicted, the swing arm 112 consists of an arm 304, one or more light arrays 308, and a sign assembly 312. The light arrays 308 in an embodiment of the invention each include multiple colored LEDs that may be made to illuminate or flash in various patterns to convey information to drivers.

The swing arm 112 in embodiments of the invention may have dimensions desired for its envisioned use. For example, it may be desired in connection with an embodiment of the invention for the arm to block an entire lane of traffic when the trailer is deployed on a road shoulder, and the width may be chosen accordingly. The height of the arm 112 may reflect, e.g., a desire to make the meaning of the flashing lights clear to drivers. The arm 112 itself may be made of any material that is strong and durable enough to perform the required functions and endure expected operating environments.

For example, in one possible embodiment of the invention, the arm 112 may be a weldment in the form of a 10 foot long polypropylene rectangle box section, fusion welded together, with internal ribs and access plates. Polypropylene may be chosen in an embodiment of the invention as a material that is particularly lightweight and so less likely to injure people in a car that strikes the arm 112. The size of the section in the embodiment may be, e.g., approximately 6×13 inches. The light arrays 308 may be mounted to the vertical side of the arm 112 such that they face traffic when the arm 112 is in the deployed position.

The proximal end of the arm 112 may take the form of a connection weldment (not pictured), which would allow the arm to be bolted to the pivot mechanism and also permit, e.g., power and/or signaling wires to pass through. The distal end of the arm 112 may, e.g., be closed off by an end plate 316 presenting a solid face.

The upper side of the arm 112 may include an attachment point—e.g., a bracket 320 bolted to the upper side of the arm 112. The bracket may be used to support an arm 112 in an embodiment of the invention, e.g., to limit sag in the arm and/or to reduce stress on the connection between the arm 112 and the pivot mechanism. For example, in an embodiment of the invention, a support pylon 324 may project upwards, out of the metal shroud enclosure 328 that contains the mechanical assembly; a guy pole 330 may extend between the bracket 320 and the support pylon 324 to provide additional support for the arm 112.

The arm/mast unit 110 in embodiments of the invention may have a sheet metal shroud enclosure 328 to protect the mechanism from weather and vandalism. The enclosures may be, e.g., bolted to the main weldment to allow easy removal for maintenance. One or more access panels 332 may be provided to allow access to the mechanism.

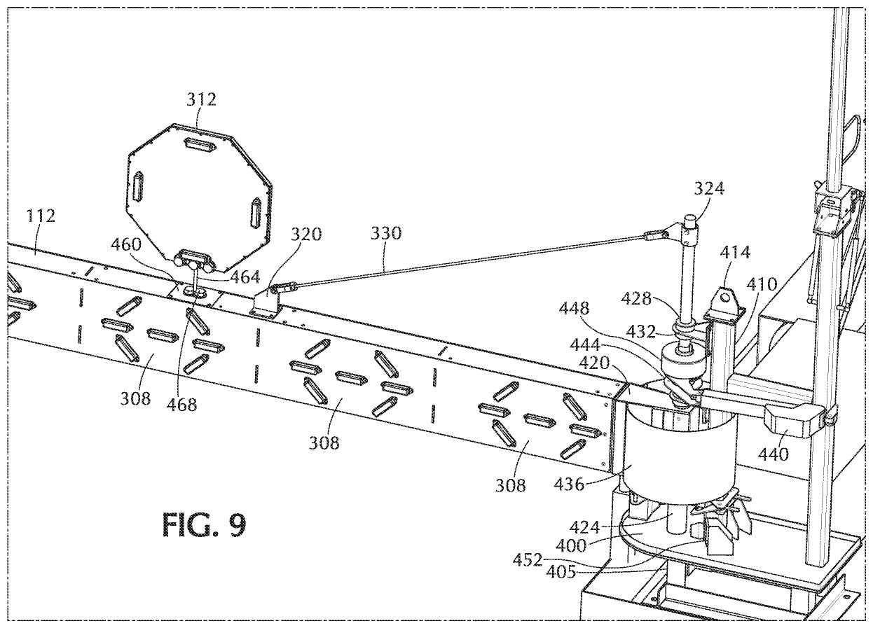

Beneath the metal shroud enclosure 328, in embodiments of the invention, is a mechanical assembly 400, e.g., as FIG. 9 depicts. As depicted, a structural interface trailer mount 405 secures the mechanical assembly to the trailer.

A main frame mount weldment 410 may in an embodiment serve as the structural support for the other elements in the mechanical assembly 400, transmitting the various forces through the structural interface trailer mount 405 to the body of the trailer 108 (FIGS. 1-3). In an exemplary embodiment, the main frame mount weldment 410 may be welded tube steel with fittings and plates to allow attachment of the various elements. It may, e.g., be powder coated for corrosion resistance and an aesthetically pleasing finish. A lift plate 414 may be located at the top of the main frame mount weldment 410, e.g., to allow for easy lifting and placing on the trailer mount 405.

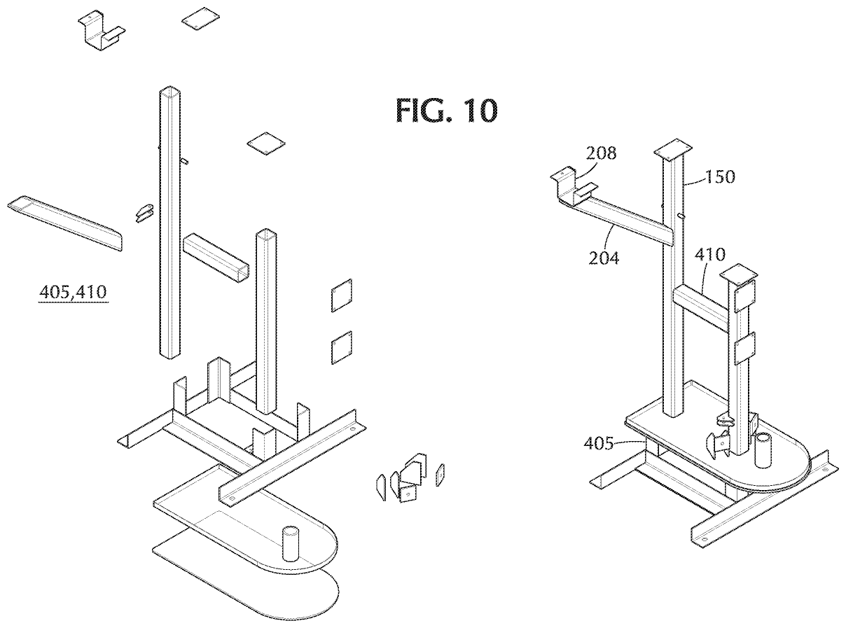

FIG. 10 depicts an exploded view (A) and assembled view (B) of a structural interface trailer mount 405 and main frame mount weldment 410 according to an embodiment of the invention.

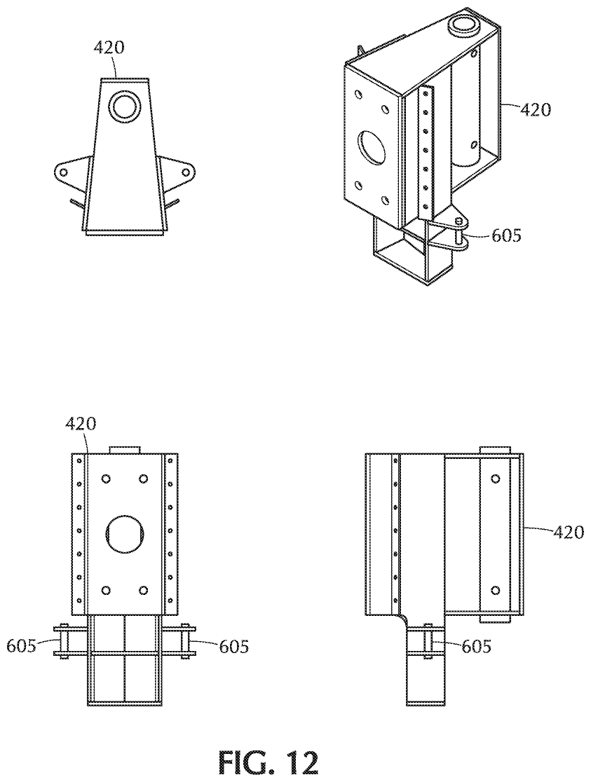

Returning to FIG. 9, in the depicted embodiment, the mechanical assembly 400 supports the arm 112 at the pivot weldment 420 to allow rotation of the arm 112 between the closed and open positions. (FIG. 12, discussed elsewhere, depicts an example of a pivot weldment according to an embodiment of the invention.) As further depicted, the arm 112 may swing, e.g., on a steel vertical pivot shaft 424. The pivot shaft bearings 428 (in an exemplary embodiment, McMaster-Carr® 6338K443 bearings) may be supported, e.g., on two offset bearing arm units 432, which, e.g., bolt to the main weldment 410. A pivot guard or guards 436 may be present, e.g., to prevent intrusion and eliminate pinch points.

The pivot guard 436 may serve also in embodiments, e.g., to seal the gap in the enclosure that permits the arm 112 to swing. The pivot guard 436 may thus move circularly with the swing of the arm, making in an embodiment a weather-tight seal at all angles of its movement.

In embodiments of the invention, the mechanical assembly 400 may open and close the arm 112 using, e.g., an electric actuator 440. (In an exemplary embodiment of the invention, a Thomson® Linear HD12B160-0300 actuator may suffice.) The actuator may transmit its force via a crank arm 444, as depicted.

Between the crank arm 444 and the pivot shaft 424, in an embodiment such as FIG. 9 depicts, there may be an overload clutch unit 448. (For example, in one embodiment of the invention, a Camco® TG200 may be used as the overload clutch unit 448.) In embodiments of the invention, the overload clutch unit 448 may allow the arm 112 and pivot 424 to “break away” or release from the actuator 440 and crank arm 444 in the event of a vehicle strike in either direction. The arm release function prevents damage to the pivot and actuator and also may prevent severe damage to the striking vehicle.

It will be appreciated that once the arm 112 and pivot 424 have broken away via the clutch 448, e.g., due to a vehicle strike, the arm 112 may swing freely until the clutch reengages. (The clutch 448 may be automatically reengaged, e.g., by manually moving the swing arm, or alternatively having the linear actuator 440 move, until the arm is back in its first position.) To limit such swinging, in embodiments of the invention, shock-absorbing bumpers 452 may be placed at the ends of travel to stop the motion, and spring loaded hook latch arms 456 may be used to capture the arm 112 at the end of travel to prevent the arm 112 from bouncing back into traffic lanes.

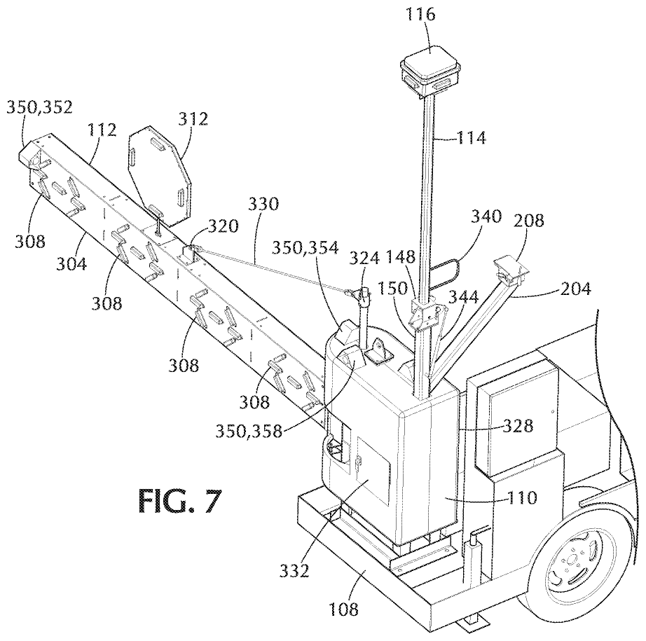

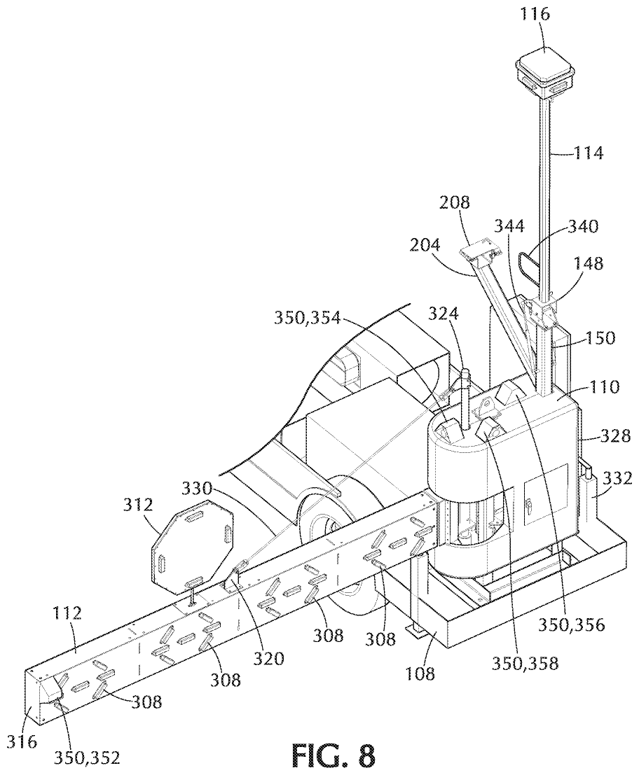

Once the arm has latched in these circumstances, in an embodiment of the invention, the latches can be released by reaching into the access door 332 (FIGS. 7 and 8) in the metal shroud enclosure 328 and pulling the latch lever. In an embodiment of the invention, the arm 112 and pivot 424 may re-index to the actuator 440, e.g., by having the controller cycle the actuator 440.

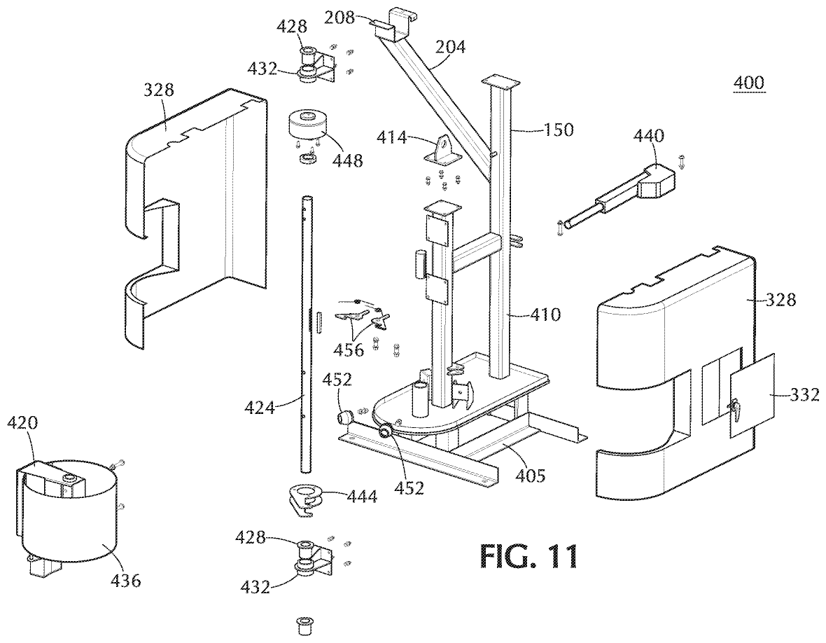

To provide more detail relevant to the preceding discussion, FIG. 11 depicts, in exploded view, a mechanical assembly 400 according to an embodiment of the invention.

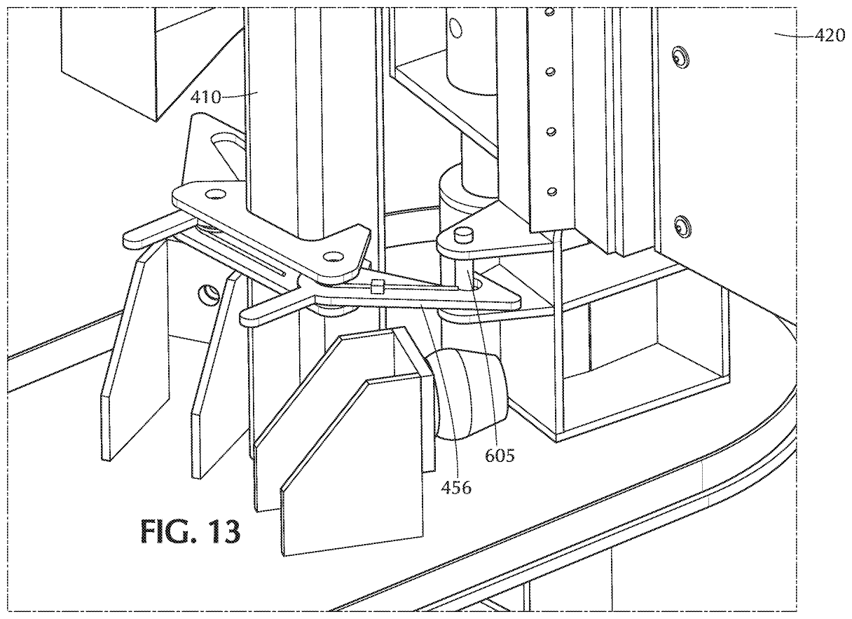

FIG. 12 depicts in four views a pivot weldment 420 according to embodiments of the invention. As discussed, upon a vehicle strike, the clutch 448 (FIG. 9) may disengage, allowing the arm 112 to swing freely, e.g., in response to the impact, until the pivot weldment 420 strikes one of two bumpers (one at each end of a possible swing) and a spring loaded latch arm 456 captures the pivot weldment 420. As FIG. 12 depicts, a pivot weldment 420 may include two pins 605, configured to be seized by one of the latch arms 456 in that circumstance. FIG. 13 depicts a latch arm engaged with a pin 605, capturing the swing arm 112.

Returning to FIG. 9, according to embodiments of the invention, a rotating sign assembly 312 may be mounted, e.g., to the sign base 460, which may, e.g., be bolted to the top of the arm 112, e.g., at approximately the halfway point. In one example, a sign assembly 312 may be, e.g., octagonal. It may be fabricated, e.g., from aluminum sheet and have a “Stop” side and a “Slow” side.

In such an example, each side may be painted a different color and house different color LED lights. On the “Stop” side, the sign may be painted red with the word “STOP” in white, and Red LEDs may be used. On the “Slow” side, the sign may be painted yellow with the word “CAUTION” in black, and Yellow LEDs may be used. In embodiments of the invention, the light patterns on the Stop/Slow sign 312 may match the colors of the lights on the swing arm 112. In an embodiment of the invention, the red LEDs may flash faster, e.g., to arouse more attention than the yellow LEDs.

The sign 312 may in an embodiment of the invention be, e.g., bolted to a vertical sign pivot shaft 464, held, e.g., by small flange bearings 468, and rotated, e.g., by a small electric motor mounted inside the arm (not pictured). The control system may control the motor and sense the position of the sign, e.g., using proximity sensors triggered by a sign limit switch arm (not pictured). Two limit switches may be provided in an embodiment of the invention: one limit switch may be provided for end of travel in each direction and one limit switch for over-travel in either direction.

It will be appreciated that the sign 312 and associated parts as described above represent only one possible embodiment of the invention. Signs of alternative shapes, sizes, and functions are possible according to embodiments of the invention, and such alternatives will be apparent to persons skilled in the arts. A fully electronic sign (not pictured) may be present in embodiments of the invention, such that some or all of either or both faces of the sign may incorporate, e.g., a programmable electronic display with, e.g., LED display elements. In such an embodiment, changes of the display on one side or the other may be accomplished, e.g., by changing the contents of the electronic display instead of, or in addition to, rotating the sign 312.

Alternatively, in embodiments of the invention (not pictured), the sign may be absent entirely.

As described above, a swing arm 112 in an embodiment of the invention such as depicted in FIGS. 1-8 may be 10 feet long. This length may be selected, e.g., to allow a 2-foot clear gap for typical 12-foot wide roadways. If a similar 2-foot gap is assumed on the opposite side roadway, this would allow a minimum of a 4-foot clear space for drivers to pass while staying away from the swing arm.

It will be appreciated, however, that in alternative embodiments (not pictured), a swing arm may have different lengths, if desired, taking into consideration, e.g., the width of roadways and/or lanes, the length of the trailer, the strength of the material from which the arm is constructed, the stability of the deployed trailer (including consideration of how outriggers, if any, are configured), and the design and limitations of the mechanical assembly.

For example, and without limiting the invention, swing arms according to embodiments of the invention may be, e.g., 5-24 feet long, 6-20 feet long, 8-16 feet long, or 8-12 feet long, with specific illustrative examples of swing arm lengths being, e.g., 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, and 24 feet. And much longer lengths may be desirable in various circumstances. Alternatively, metric lengths approximating these ranges and specific lengths may be chosen. Moreover, in a particular embodiment, the precise length of the beam arm may not be a critical design choice, so a length approximating any of these lengths or ranges may be acceptable if the resulting arm behaves similarly under operating conditions.

It will be appreciated that users may wish to use a road closure and site observation system 100, according to embodiments of the invention, in various environments, in which swing arms of varying lengths may be desired. Thus, in embodiments of the invention, a system 100 in embodiments of the invention may permit one swing arm to be disconnected from the mechanical assembly 400 and another, different swing arm to be removably attached in its place. For example, modular wiring connectors (not pictured) may connect wires coming out of the mechanical assembly to those entering swing arms of various dimensions, allowing easy connection and disconnection of power and control signals. A swing arm in such an embodiment may be, e.g., unbolted from a pivot and disconnected electrically from the apparatus; a replacement arm may then be connected electrically and bolted to the apparatus in place of the old swing arm. This feature may also permit, e.g., replacement of an arm that has been compromised, e.g., by being struck by a vehicle.

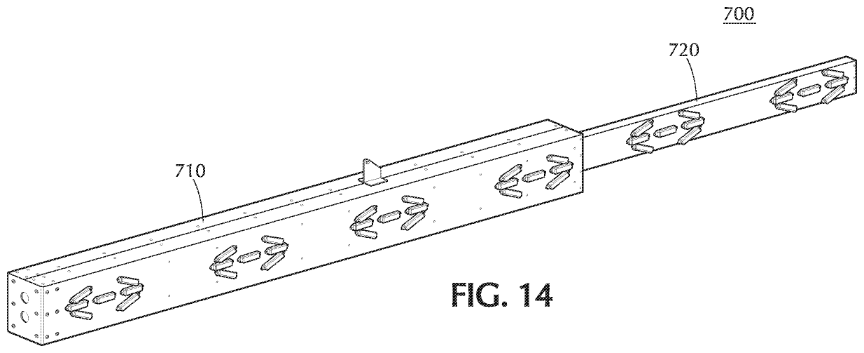

In embodiments of the invention, a swing arm may have an effectively variable length, e.g., through telescoping. FIG. 14 depicts an example of a telescoping swing arm 700 according to an embodiment of the invention. As depicted, the telescoping swing arm 700 includes an outer section 710 and an inner section 720. Tracks or other means (not pictured) inside the outer section 710 may permit the inner section 720 to be extended from the outer section 710 and retracted back into it, e.g., manually (by, e.g., pulling and pushing the inner section 720) or by an electric linear actuator (not pictured) disposed within the outer section 710.

In an embodiment of the invention, a swing arm (not pictured) may in effect be doubled, e.g., by using a swing arm with two segments, joined, e.g., by a hinge, with a flexible electrical connection between the segments. In such an embodiment, the segments may be folded together, e.g., for transport or storage, and then opened when deployed, effectively doubling the length the arm. A latch or other manual or automatic mechanism may secure the segments when fully opened, creating in effect a long, straight arm, and it may be released when the arm's more compact configuration is desired. Such doubling may, e.g., expand a 10-foot swing arm to a 20-foot one, expand a 20-foot swing arm to 40 feet, or expand a 40-foot swing arm to 80 feet, which may, e.g., suffice to block 6.5 lanes of traffic.

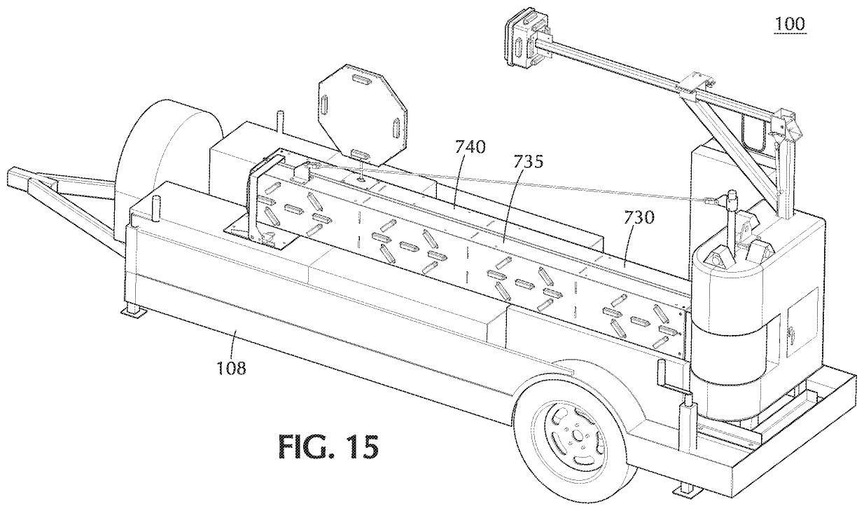

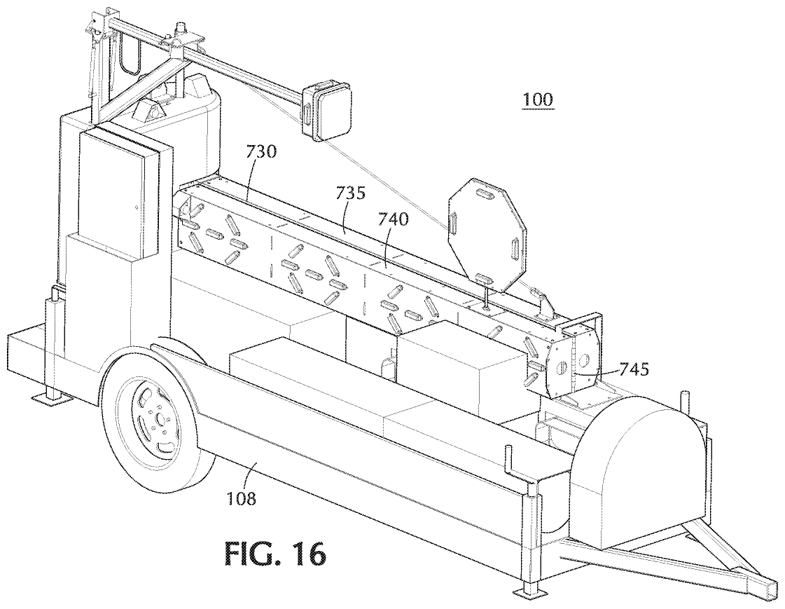

FIGS. 15 and 16 depict, in two views, a system 100 with a doubled arm 730 according to embodiments of the invention. As depicted, the arm 730 has two segments, a proximal segment 735, and a distal segment 740, joined by a hinge 745. The arm 730 is depicted in a open position, i.e., it is rotated parallel to the long axis of the trailer 108 and is not placed to obstruct traffic. The arm 730 is also doubled on itself, e.g., for storage and held in position, e.g., for transport or storage.

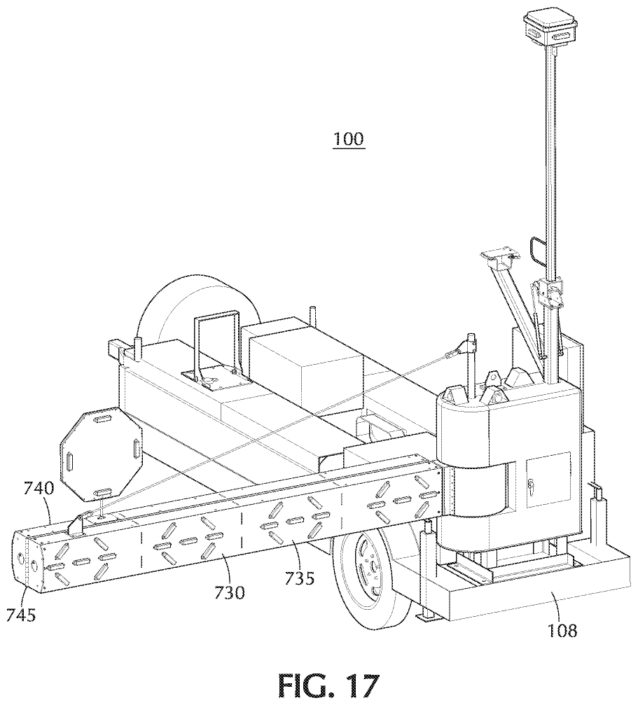

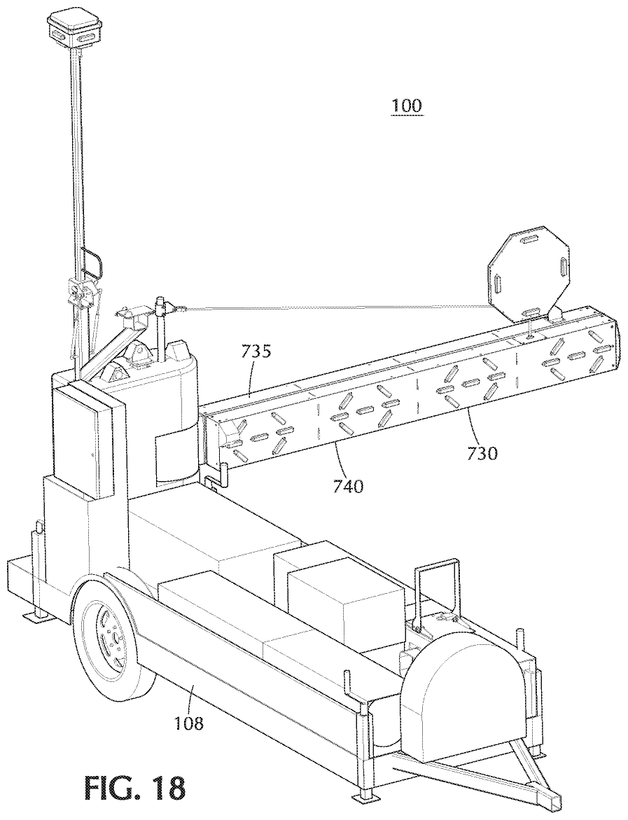

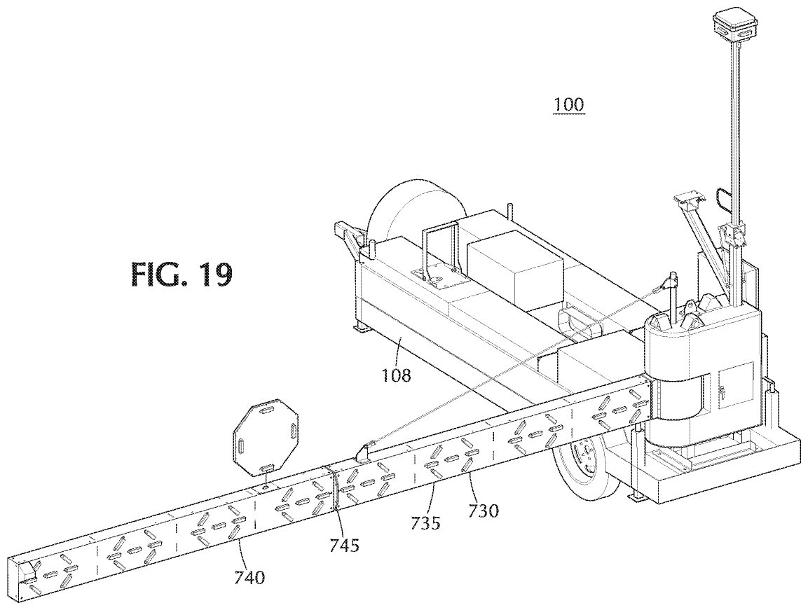

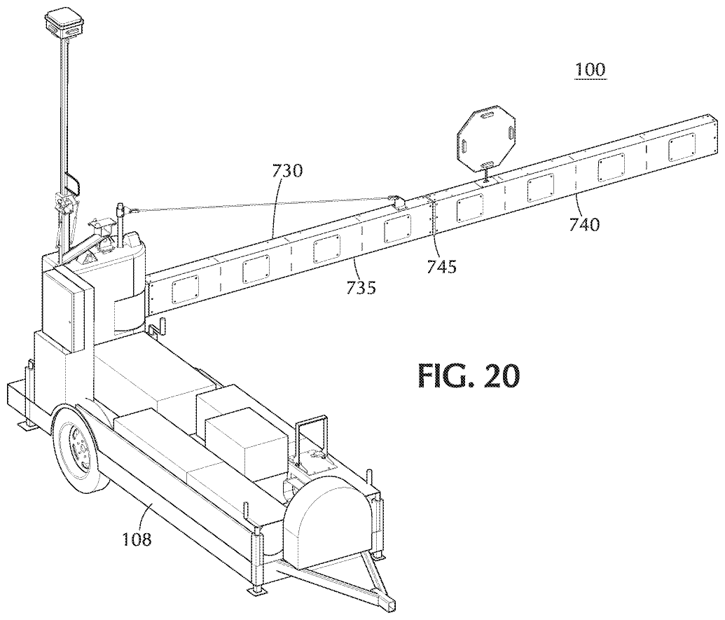

FIGS. 17 and 18 depict, in two views, a system 100 as in FIGS. 15 and 16 with the arm 730 still folded, but in closed position, i.e., positioned as if across a lane of traffic. According to embodiments of the invention, the system may be fully operable in the configuration that FIGS. 17 and 18 depict. FIGS. 19 and 20 depict such a system 100 according to an embodiment with the arm 730 in open position and fully extended.

Returning, e.g., to FIGS. 7 and 8, a mast assembly in an embodiment of the invention may comprise, e.g., a steel tube mast 114, which supports the mast component enclosure 116 at the top. The mast 114, in an embodiment such as depicted, may be connected via a hinge 148 to the lower mast support 150. The mast 114 may be raised, e.g., manually, from a stowed horizontal position (as in FIGS. 4-6) to a vertical position (as in FIGS. 1-3, 7, and 8). A handle 340 may be attached (e.g., welded) to the mast to make raising and lowering the mast more convenient, and, in an embodiment such as FIGS. 7 and 8 depict, two gas shock springs 344 may ease raising and lowering the mast 114. A latch, locking pins, or other mechanism (not pictured) may secure the mast 114 in the vertical position until it is desired to lower the mast 114 again.

The mast 114 may be of any height desirable, consistent with, e.g., the length of the trailer 108, the weight of the bar (and its effect on raising and lowering the mast 114), the stability of the raised mast 114 and its effect on the stability of the apparatus as a whole, etc. Without limiting the generality of the foregoing, according to one exemplary embodiment, the mast 114 in the vertical position may raise the mast component enclosure 116 to a height above the ground of approximately 14 feet. In embodiments of the invention, this height may be chosen, e.g., to permit the trailer 108 to be towed with the mast 144 up without interference, e.g., from 15-foot overpasses.

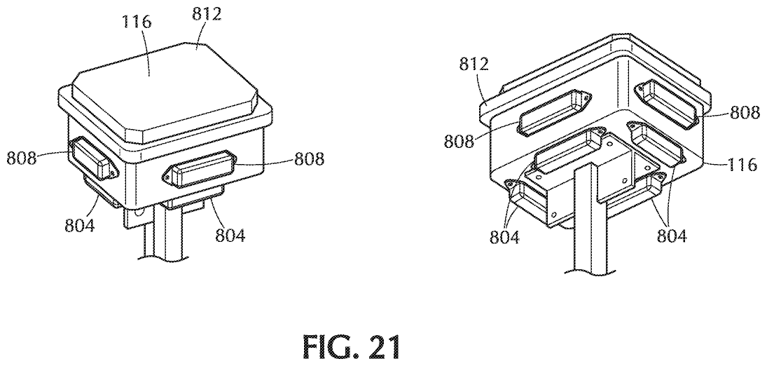

FIG. 21 depicts, from two perspectives, a mast component enclosure 116 according to an embodiment of the invention. As depicted, the enclosure 116 includes two sets of exterior lights. First, on the underside of the enclosure 116, there are 4 brilliant flood lights 804, which, e.g., illuminate the area around the trailer 108. Second, each of the four sides of the enclosure 116 has a lighting unit 808, such that the four lighting units 808 may act, e.g., as a beacon.

The nature and behavior of the beacon lighting units 808 may vary, e.g., depending on the embodiment of the invention. In an exemplary embodiment of the invention, the lighting units 808 may consist of blue and red LEDs that may be made, e.g., to flash by controls within the system 100 or remote controls. In embodiments of the invention, such flashing may take the form of illuminating, e.g., two opposed beacon lighting units 808 while the other two are dark, and then reversing the arrangement so that only the other two beacon lighting units 808 are illuminated. In embodiments of the invention, another color or colors may be present in addition to, or instead of, blue, red, or both. The control system may support, e.g., one or more patterns of steady and/or flashing lights.

The mast component enclosure 116, in embodiments of the invention, may contain, e.g., one or more devices (not pictured) for the purpose of data acquisition, communication, or both. In embodiments of the invention, the enclosed device or devices may support, e.g., GPS (which may be or include, e.g., a GPS tracker), cellular data and/or voice, Wi-Fi®, and wired Ethernet, among other possibilities. A suitable device according to an exemplary embodiment of the invention may be, e.g., a Sierra Wireless® AirLink® MP70 or AirLink® RV50X.

Power and/or data cables may pass, e.g., through the bottom of the mast component enclosure 116, into the mast 114, and then connect as necessary with other components of the system 100.

The enclosure 116 may in embodiments of the invention be made from any sufficiently rugged and weatherproof material, although it will be appreciated that it may be desirable for the enclosure 116 to be transparent to radio frequencies of certain wavelengths. Thus, in an embodiment of the invention, the enclosure 116 may be made of a material such as, e.g., fiberglass. Alternatively, in an embodiment of the invention, five sides of the enclosure 116 may be made, e.g., of sheet metal, with the lid 812 made of radiotransparent material. In still another embodiment, the enclosure may be made of a substantially radiopaque material (e.g., sheet metal), and one or more antennas (not pictured) may be mounted on the exterior and fed, e.g., by one or more cables passing through the walls of the enclosure 116.

The enclosure 116, may in embodiments have, e.g., a hinged lid 812 that can be secured in a closed position, e.g., by a latch (not pictured). The lid may be, e.g., gasketed, to maintain weathertightness, and other openings in the enclosure may be weatherproofed, e.g., by appropriate use of gaskets and/or caulk.

Returning to FIGS. 7 and 8, in embodiments of the invention, the system 100 may include one or more camera assemblies 350. For example, in an embodiment such as FIGS. 7 and 8 depict, four camera assemblies are present.

FIG. 14 depicts a video camera assembly 350, according to an embodiment of the invention, viewed front-on. As depicted, the assembly comprises an outdoor video camera 905 protected by a sheet-metal cover 910. The camera 905 and the cover may, e.g., rest on and be affixed to a mounting surface 910. Deployed, e.g., as FIGS. 7 and 8 depict, the mounting surface 910 for 3 of the cameras may be the top of the metal shroud enclosure 328, and, for the fourth camera, the mounting surface 910 may be a surface of the swing arm 112.

Power and video (and possibly audio) cables (not pictured), in an embodiment of the invention may run, e.g., from each camera 905 through a respective hole in the mounting surface 910, and from there to other components of the system 100 as necessary.

In an embodiment such as FIGS. 7 and 8 depict, the camera assemblies 350 (and thus the cameras 905 they contain) are aimed in 4 different directions. As depicted, the camera 352 at the end of the swing arm 112 is aimed along the line of the arm 112, towards the arm/mast assembly 110, and may be used to capture the arm's selected light position displayed, e.g., on the screen in the control enclosure. An outward-facing camera 354, mounted atop the metal shroud enclosure 328, is aimed facing opposite the arm camera 352, and is therefore placed to capture, e.g., a side view of passing traffic. The other two cameras are a forward-facing camera 356 and a rear-facing camera 358.

The number and disposition of camera assemblies 350 and cameras that FIGS. 7 and 8 depict are illustrative, not limiting. Other embodiments of the invention may omit one or more of the depicted camera assemblies 350. Other embodiments of the invention may include one or more other cameras in addition to or instead of one or more of the cameras positioned as FIGS. 7 and 8 depict.

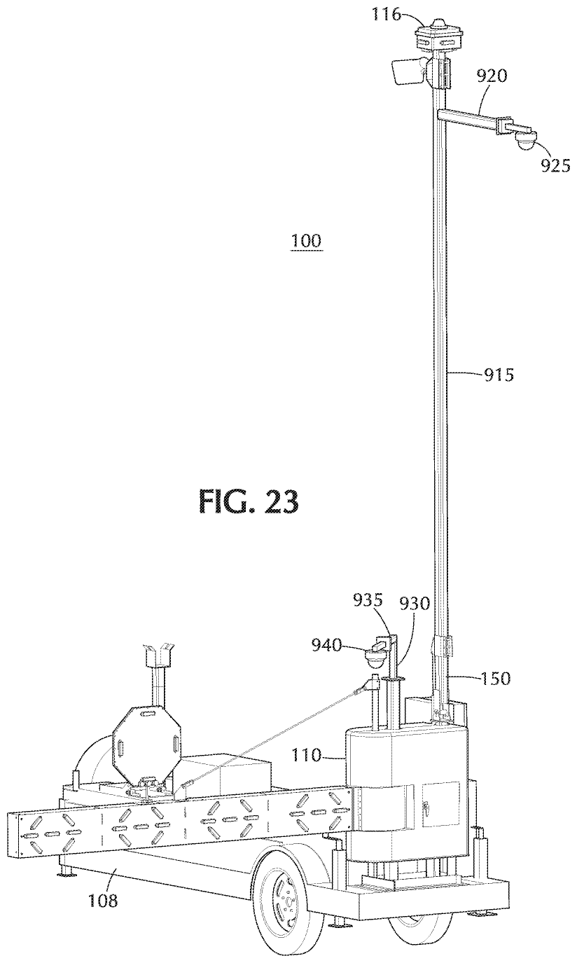

FIG. 23 depicts a system 100 according to an embodiment of the invention with a longer mast 915 extending from the lower mast support 150. For example, in an embodiment such as FIG. 23 depicts, the mast 915 may raise the mast component enclosure 116 20 feet about the ground. An arm 920 extends horizontally behind the trailer 108 from the top of the mast 915, immediately below the mast component enclosure 116. A camera 925 may be placed at the end of the arm 920, positioned to provide video, e.g., of the site around the trailer 108.

As FIG. 23 depicts, a second, shorter mast 930 may project vertically from the arm/mast assembly 110, ending in a horizontal arm 935. The horizontal arm 935 supports a camera 940 positioned, e.g., to provide video of, e.g., the area surrounding the operator's position.

The cameras 925, 940 in an embodiment such as FIG. 23 depicts may, e.g., be aimed in any direction deemed desirable and may, e.g., be mounted using a device allowing local or remote control, e.g., by a local or remote operator, of the camera's position and/or orientation.

In the embodiment that FIG. 23 depicts, the system includes the cameras 925, 940 instead of the fixed camera assemblies 350 (and cameras) that, e.g., FIGS. 7 and 8 depict. In alternative embodiments (not pictured), a system may comprise both the fixed cameras of, e.g., FIGS. 7 and 8, and the mast-mounted rotatable cameras 925, 940 of FIG. 23. In such embodiments of the invention, as discussed elsewhere, the two kinds of cameras may in an embodiment be considered parts of two distinct video systems, with video from each system being treated differently from the other.

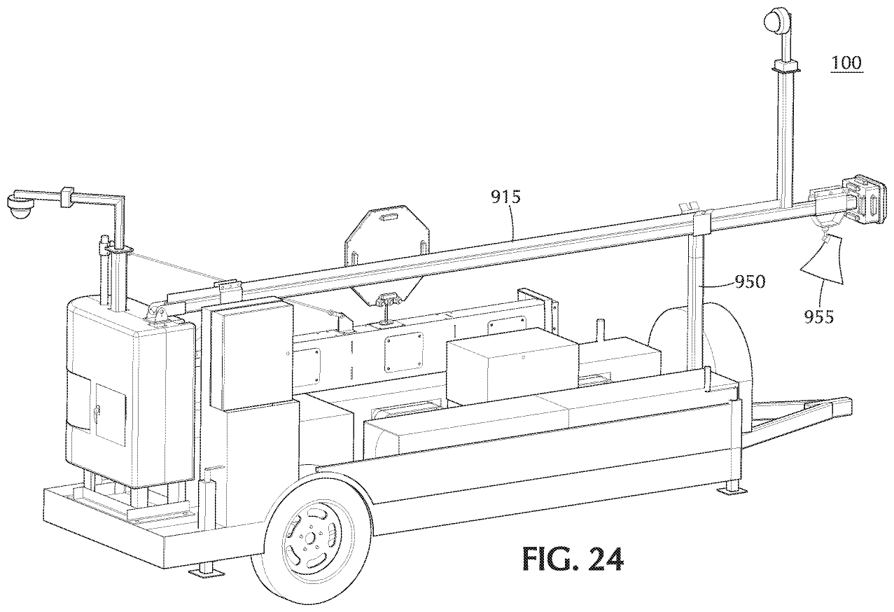

FIG. 24 depicts in two views a system 100 as in FIG. 23 with the mast 915 in a horizontal position, according to embodiments of the invention. As depicted, the mast is supported and held by a support 950, which, in the depicted embodiment is configured to retain the mast 915, e.g., for transport or storage. In the embodiment that FIG. 24 depicts, a public address horn 955 is placed near the top of the mast 915 as well.

According to embodiments of the invention, the system may be powered directly, e.g., by high-capacity 12 VDC batteries (not pictured), which may be located, e.g., in a battery enclosure 140 (FIGS. 1-3). The batteries, in turn, may in embodiments of the invention be charged by a system that may include, e.g., propane storage tanks 138, electrically operated valves, propane level gauges and a propane power generator and a 120 VAC battery charger.

According to embodiments, the system may operate entirely from the batteries until the voltage drops to a predetermined level. The PLC in such an embodiment may, e.g., monitor the battery level and control the propane tanks (through the electrically-operated valves) and the generator. When the PLC detects that the battery level has reached the predetermined level, it may activate the generator and cause it to run, e.g., until it recharges the batteries to a full charge.

In embodiments of the invention, the PLC may, e.g., feed the generator from only one tank at a time, relying exclusively on that tank until it is empty. In such an embodiment, when one tank is empty, the PLC may automatically switch to the next tank to draw in fuel.

In an embodiment of the invention such as FIGS. 1-3 depict, the generator (not pictured) may be covered, e.g., by the generator enclosure 142. It may further be secured atop a generator support 155, which in turn may be secured to the upper surface of the trailer. In embodiments of the invention, the generator enclosure 142, the generator support 155, or both may be, e.g., vented to allow air to reach the generator's intake and/or cool the generator. For example, the generator according to an embodiment of the invention may be mounted on a 10-gauge steel frame and have a 10-gauge steel frame cage enclosure 142 for security.

In an exemplary embodiment of the invention, the generator for the system may be, e.g., a Cummins Onan® QG 2500 LP, rated to produce 2500 watts of 120 volt power at 20.8 amps. The generator in an embodiment may be, e.g., hard-wired to a battery charger (not pictured), which in turn may be hard-wired to the battery or batteries. In an embodiment of the invention, the battery charger may be, e.g., in the battery enclosure 140.

Also in an exemplary embodiment of the invention, the fuel system for the generator may be, e.g., four horizontally mounted propane tanks 138. Each tank 138 may hold, e.g., 29.3 gallons, yielding a total of 117.2 gallons of propane.

Each tank in an embodiment of the invention may be connected, e.g., via a stainless steel braided hose (not pictured), to a manifold (not pictured) Each tank 138 may have an electronic valve (not pictured) on the manifold, and the valves may, e.g., be controlled by the PLC to open and close each tank. Each tank in an embodiment may, e.g., be connected to a visual gauge, an electronic gauge, or both, to monitor fuel levels. The fuel tanks are housed in a steel cage constructed from 10 gauge steel that has enough open area to ensure no fumes will get trapped inside.

In an exemplary embodiment of the invention, the battery charger may be a PowerMax PM3, which may be rated to deliver 13.4 volts-16.5 volts at 120 amps. The charger in the embodiment is powered by 120 volts AC supplied by the generator. The 13.4 volts-16.5 volts DC then charges, e.g., the 12 volt batteries.

The identification of specific models or manufacturers of components of the power/generation system is illustrative, not limiting. It will be appreciated by those skilled in the art that other devices, including devices with differing specifications, will be suitable for use in connection with embodiments of the invention.

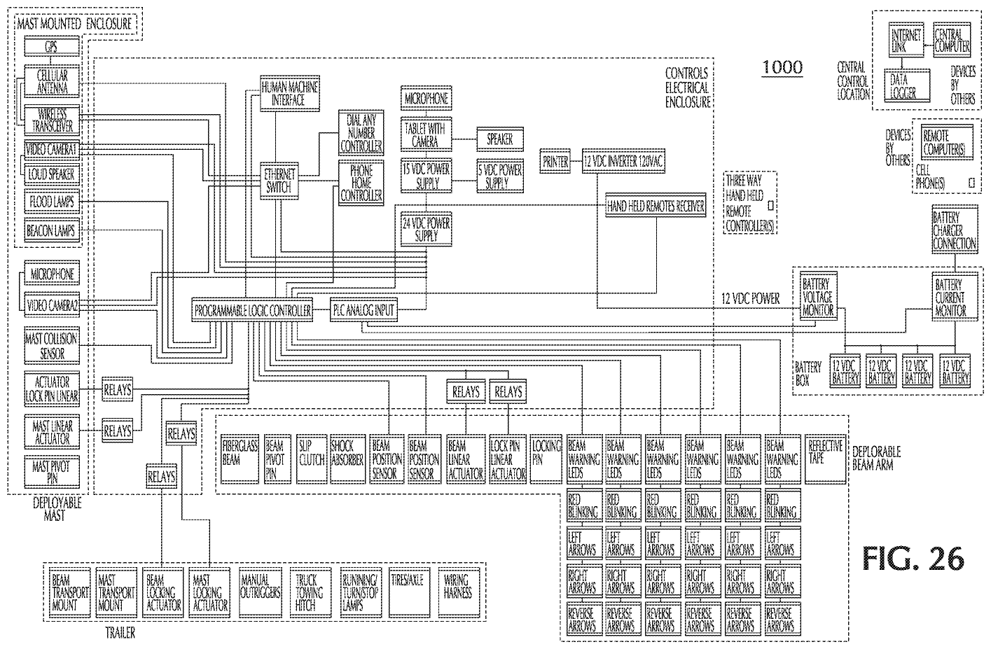

According to embodiments of the invention, the control enclosure 120 may house, e.g., a PLC and/or other components involved in operation of a system 100 according to embodiment of the invention. FIG. 26 is a block diagram 1000 that illustrates schematically the components of a system and their interconnections according to an exemplary embodiment of the invention.

In an embodiment of the invention, a control enclosure 120 may include, e.g., a lockable door 230 that opens to reveal, e.g., one or more devices for controlling and/or otherwise interacting with a system 100 according to an embodiment of the invention.

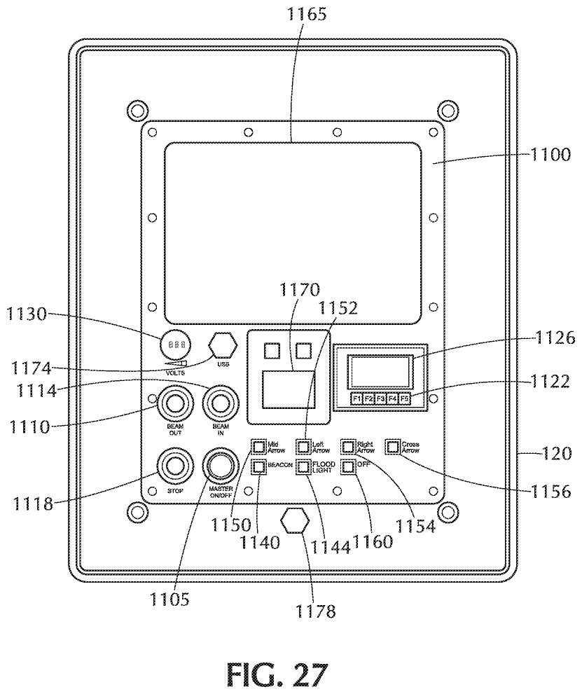

FIG. 27 depicts a control panel 1100, comprising a screen 1165, inside a control enclosure 120 according to an embodiment of the invention. According to an embodiment of the invention, all elements in the control panel, including without limitation push buttons and screens, are fully waterproof. Thus, in such an embodiment, an operator can control the system safely in the rain.

The control panel 1100 may interface with the PLC (not pictured), e.g., to control operation of the system 100. The screen 1165, for its part, may interface with the PLC to control, e.g., the four video cameras.

As a most basic example, the depicted control panel 1100 includes a knob 1105 serving as a master on/off switch. (As a matter of practice, but not as a limitation to the invention or any claim, it is envisioned that, in most circumstances, the master on/off switch will be in the “on” position virtually all the time the system 100 is not in transport or storage.)

In an embodiment of the invention, a control panel 1100 may include, e.g., waterproof buttons to control the motion of the swing arm. For example, as depicted, the control panel 1100 includes a “BEAM OUT” button 1110, e.g., to direct the PLC to cause the mechanical assembly to rotate the swing arm 112 away from the body of the trailer 108, i.e., to obstruct traffic. Conversely, the “BEAM IN” button 1114 may cause rotation of the swing arm 112 back to the trailer 108. A “STOP” button 1118 may interrupt the rotation of the swing arm 112, e.g., in emergency.

Elements inside the control panel 1100 in an embodiment of the invention may, e.g., control and/or give information about the status of various subsystems. As depicted, for example, a row of buttons 1122 may engage and disengage (e.g., as a toggle) the respective valves controlling the individual propane tanks. (Engaged valves are opened only when the generator is running.) Immediately above the row of buttons 1122, in the depicted embodiment, a display may indicate, e.g., the charge remaining in each propane tank as a series of bar graphs (not pictured), each graph being displayed immediately above the button 1122 controlling the respective tank's valve.

The current battery voltage may appear, e.g., in a digital display 1130 within the control panel 1100. Relatedly, a battery monitor, e.g., within the main panel, may determine when the batteries need to charge. As described, battery charging in embodiments of the invention may be accomplished by running the generator through the use of the PLC. For example, in an embodiment of the invention, the PLC may enable some or all of the propane supply solenoid valves (e.g., reflecting the settings of the panel buttons 1122) and then may engage the generator's starter. The PLC may turn off the starter once the generator is engaged.

Once the battery is charged, the PLC may then stop the generator.

In an embodiment such as FIG. 27 depicts, the HMI may include, e.g., a button 1140 to toggle the mast beacon 808 (FIG. 13) and/or a button 1144 to toggle the mast floodlight 804 (FIG. 13).

According to embodiments of the invention, the control panel 1100 may include a series of buttons to control the lighting arrays on the swing arm. For example, in an embodiment of the invention, a button labeled “RED FLASHING” 1150 may cause lights within the lighting arrays, e.g., to flash red in a pattern.

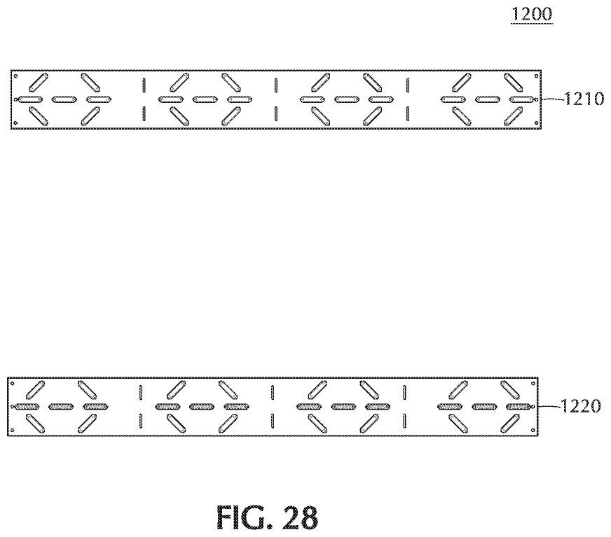

FIG. 28 illustrates an example of such a “RED FLASHING” pattern 1200 according to an embodiment of the invention. According to the depicted pattern 1200, the lighting arrays alternate between state 1210, in which no segments are illuminated, and state 1220, in which the three horizontal segments of each array emit red light. The alternation period may vary depending on the embodiment of the invention, but as illustration and not as limitation, embodiments of the invention may spend, e.g., 0.5-2 seconds in each state before switching to the other.

Returning to FIG. 27, the control panel 1100 may in an embodiment include a button labeled “LEFT ARROW” 1152, which, when selected, may cause lights within the lighting arrays, e.g., to display a progressive series of yellow (or amber) lights having the appearance of a leftward-moving arrow.

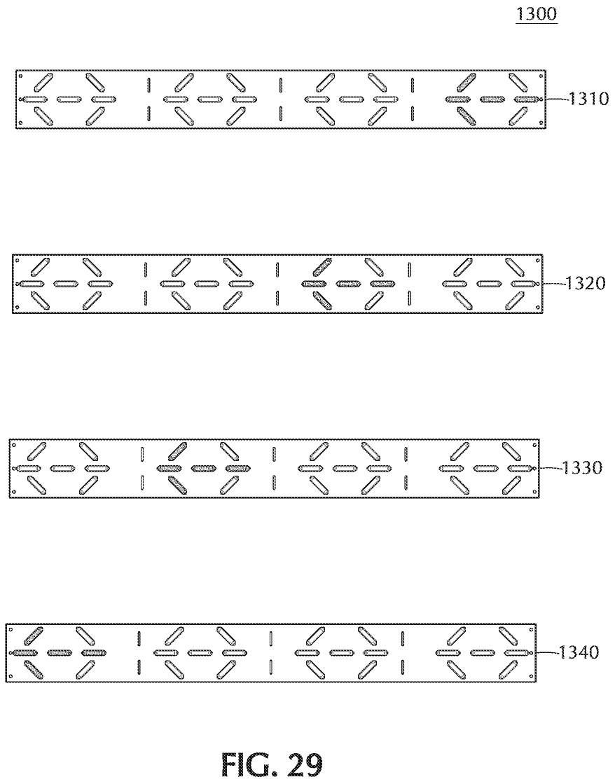

FIG. 29 illustrates an example of such a “LEFT ARROW” series 1300 according to an embodiment of the invention. According to the depicted series 1300, the lighting arrays progress from state 1310 to state 1320, then to state 1330, and then to state 1340, at which point the arrays may return to state 1310, where the cycle repeats. As depicted, in each state, five segments of one of the arrays, forming an arrow shape, emit amber light, while all segments of all other arrays remain dark. As illustration and not as limitation, each state according to embodiments of the invention may last, e.g., 0.5-2 seconds before the progression moves to the next state.

Returning to FIG. 27, the control panel 1100 may in an embodiment include a button labeled “RIGHT ARROW” 1154, which, when selected, may cause lights within the lighting arrays, e.g., to display a progressive series of yellow (or amber) lights having the appearance of a rightward-moving arrow. In embodiments of the invention, the “RIGHT ARROW” series may be, e.g., the mirror image of the “LEFT ARROW” series 1300 that FIG. 29 depicts.

As FIG. 27 depicts, the control panel 1100 may in an embodiment include a button labeled “CROSS ARROW” 1156, which, when selected, may cause lights within the lighting arrays, e.g., to display an alternating pattern of yellow (or amber lights) having the appearance of outward-directed arrows.

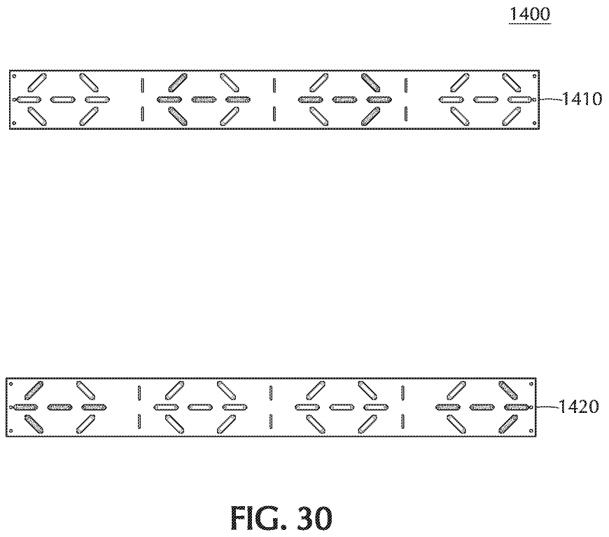

FIG. 30 illustrates an example of such a “CROSS ARROW” pattern 1400 according to an embodiment of the invention. According to the depicted pattern 1400, the lighting arrays appear first in state 1410, in which an inner two of the arrays display amber segments forming arrow shapes pointing to the ends of the swing arm, while no segments are illuminated in the outer two arrays. This alternates with state 1420, in which the outer two arrays display amber segments forming arrow shapes pointing to the ends of the swing arm, while no segments are illuminated in the inner two arrays. The alternation period may vary depending on the embodiment of the invention, but as illustration and not as limitation, embodiments of the invention may spend, e.g., 0.5-2 seconds in each state before switching to the other.

As previously described, in embodiments of the invention, a swing arm 112 may include, e.g., a rotatable sign 312 (FIGS. 7 and 8). According to embodiments of the invention, the PLC, in addition to causing the light arrays on the swing arm to illuminate, e.g., in various patterns, may cause the sign to rotate to display a message appropriate to the illumination pattern. For example, when the swing arm 112 is displaying the “FLASHING RED” pattern to traffic, the PLC may cause the side of the sign 312 bearing a “STOP” sign to face traffic as well and/or cause red lights on the sign 312 to flash. Or when the swing arm presents one of the arrow-based displays, the PLC may also cause the sign 312 to display a yellow “CAUTION” or “SLOW” sign to traffic and/or cause amber lights on the sign 312 to flash.

Returning to FIG. 27, an “OFF” button 1160 may turn off the lights on the swing arm. If lights have been made to flash on a sign 312 (FIGS. 7 and 8) on the swing arm 112, the “OFF” button may deactivate those flashing lights as well.

In an embodiment of the invention, the control panel 1100 (FIG. 27) may include a video screen 1165, which may be, e.g., an electronic display or a touchscreen. In an embodiment of the invention, the video screen 1165 may display, e.g., live video from one or more cameras configured such as FIGS. 7 and 8 depict (e.g., using a split-screen display). In such an embodiment, the operator may have a real-time view of, e.g., the behavior of the swing arm and its lights, as well as of traffic approaching, passing, and leaving the system's 100 area, from both directions, while keeping a safer distance from the road.

In one such embodiment, the video feed from the four cameras 352, 354, 356, 358 may be continuously stored, e.g., in a hard drive (not pictured) that the system 100 incorporates. For example, in an embodiment, the hard drive may store approximately one month's continuous video. A touchpad 1170 (FIG. 27) may allow an operator to select some or all of the stored video and, e.g., download it to a device attached to USB port 1174.

It will be appreciated that by making such a video record available, in connection with embodiments of the invention, a system 100 may function as a forensic tool, providing reliable evidence of, e.g., accidents, reckless driving, speeds of vehicles, and vandalism of the system 100 itself.

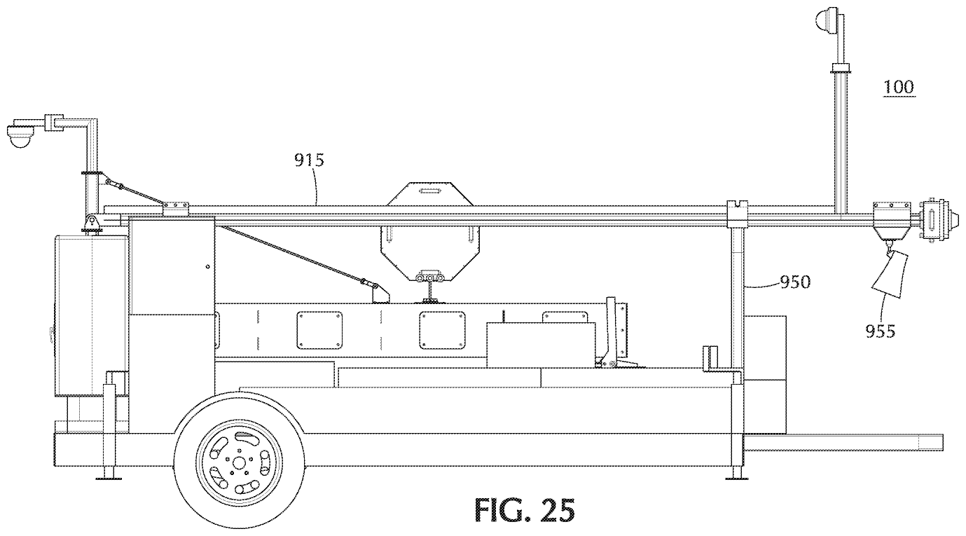

Alternatively, in an embodiment of the invention that includes a mobile or aimable camera, e.g., as FIGS. 23-25 depict, a trackpad or other device 1170 may be used, e.g., to control either camera or both cameras.

A control panel 1100 according to embodiments of the invention may include, e.g., one or more connectors. For example, as depicted, the control panel 1100 includes two USB connectors 1174, 1178. One connector 1174 may be intended, e.g., to receive a storage device (not pictured), upon which live video from one or more cameras may be stored, e.g., in real time. The other USB connector 1178 may, e.g., permit interfacing an external device with the PLC. As depicted, both USB connectors 1174, 1178 are provided with covers, which may, e.g., prevent ingress of water due to rain, etc.

Alternatively, in an embodiment of the invention, a HMI may include, e.g., a touch screen with “soft” buttons” or controls corresponding to some or all of the controls depicted in the control panel 1100 of FIG. 27. FIG. 23 depicts an example screen display 1500 of an HMI according to an embodiment of the invention.

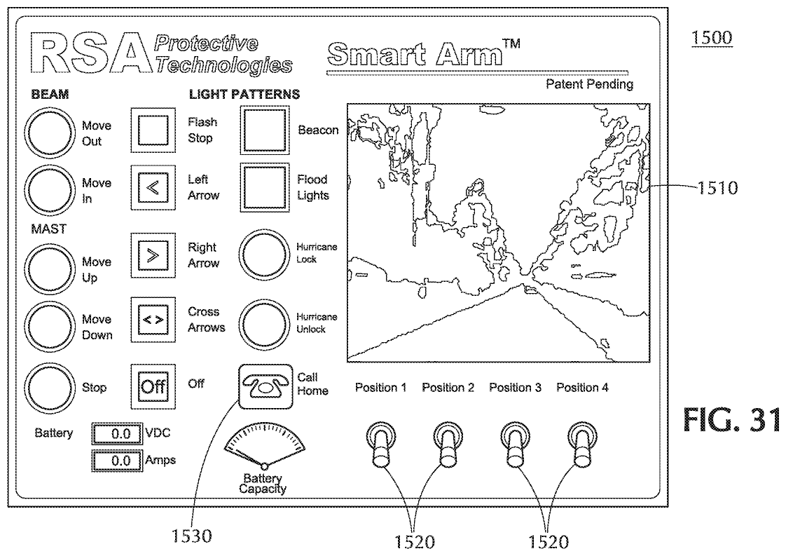

The HMI 1500 of FIG. 31 displays video 1510, e.g., from one of the cameras included by the system 100. In an embodiment of the invention incorporating, e.g., cameras such as described in connection with FIGS. 7 and 8, the HMI 1500 (FIG. 31) may display, e.g., live video from one or more (e.g., using a split-screen display) of the cameras, e.g. providing functions similar to those discussed in connection with FIG. 27.

Alternatively, in an embodiment of the invention, the HMI 1500 may be configured to display video 1510 from one or more cameras such as described in connection with FIGS. 23-25. Such cameras, in an embodiment of the invention, may be capable of turning, e.g., through 360 degrees, and in such an embodiment, a number of positions may be predefined for the camera's rotation. The depicted HMI 1500, for example, may reflect a camera with 4 predefined positions, and the soft controls may include, e.g., 4 corresponding soft buttons 1520, allowing the operator to choose the directional view that appears in the video display 1510.

In embodiments of the invention, the PLC, HMI, or both, may be interfaced with a device (not pictured) permitting reception of signals, e.g., from a local, special-purpose remote control (not pictured). In embodiments of the invention, all basic control functions (including, e.g., beam opening and closing and/or operation of some or all of the lighting systems on the swing arm and/or the mast component enclosure) may also be accessed from the remote control, which can be used from any location in the vicinity of the system, e.g., without opening the component enclosure door 230 (FIGS. 4-6), possibly allowing safe and easy setup and operation even in inclement weather.

A system 100 according to embodiments of the invention may include, e.g., a tablet PC (not pictured). The tablet PC may be secured, e.g., to the inner surface of the control enclosure door 230; in this configuration, an operator may, e.g., face both the HMI and the tablet PC simultaneously, for convenient access to both devices. The tablet PC may in embodiments of the invention draw power, e.g., from the same 12-volt supply that draws from the batteries.

According to embodiments of the invention, the tablet PC may include, e.g., a camera and/or microphone, such as may be suitable for audio and/or video teleconferencing.

The tablet PC may participate, e.g., in one or more local- and/or wide-area data networks by virtue of the networking device enclosed in the mast component enclosure 116 (FIGS. 1-3). The tablet PC's connection with the networking device may in embodiment be via, e.g., a wired Ethernet, Bluetooth®, or Wi-Fi®.

Other participants in the system's local area network may include, e.g., some or all cameras, the HMI, and/or the PLC, among other examples. Thus, the tablet PC may in an embodiment of the invention receive streaming video via the LAN from any or all of the cameras simultaneously, may store data (including, e.g., the video) locally (e.g., on a hard drive or SSD), and/or may make some or all of this stored data available for download, e.g., onto a storage device such as a USB thumb drive.

In some of the embodiments of the invention with cameras such as FIGS. 7 and 8 depict, live and/or stored video may not be available to the tablet PC from some or all of the cameras. Access to the stored video in such an embodiment may be limited, e.g., to direct download as described above.

Alternatively, in embodiments of the invention with two parallel video systems, e.g., as described above, video from one set of cameras (e.g., rotatable cameras such as FIGS. 23-25 depict) may be available to or through the tablet PC, while video from the other set (e.g., fixed cameras such as FIGS. 7 and 8 depict) may not be available to or through the tablet PC.

A tablet PC according to embodiments of the invention may have installed various software, including e.g., an office suite and/or engineering software packages, as well as, e.g., custom software designed to operate with the system 100. For example, the PLC may be programmed to accept control, e.g., via the LAN, and software on the tablet PC may perform, e.g., some or all functions of the HMI.

The networking device may in embodiments route connections, e.g., to a WAN such as the Internet, via, e.g., a cellular data link. Taking advantage of such network access, the tablet PC may have installed, e.g., software permitting synchronous and/or asynchronous messaging, including, e.g., video, audio, text, and/or other data. (Such software may include, e.g., teleconferencing software.) By also participating in this extended network, the PLC may be remotely controllable, e.g., via the Internet, from one or more devices such as desktop PCs, tablets, and/or smartphones. For example, a remote device may present a display similar to the soft HMI 1500 of FIG. 31, allowing the user to enter commands that are passed to the PLC and executed as if entered locally by an operator.

By participating in both a LAN and WAN, a system 100 according to embodiments of the invention may support, e.g., a “call home” function. According to an embodiment of the invention, this function may be activated, e.g., by a soft button 1530 (FIG. 31) presented as part of the HMI display 1500.

Upon activation, a call home function according to embodiments of the invention may cause a PLC to attempt to send, e.g., via the networking device and the WAN, one or more messages to a remote location, requesting that the remote location attempt to contact the tablet PC via the WAN. For example, in one embodiment of the invention, a message, or versions of it may be sent by VoIP to a predetermined voice mailbox, using text-to-speech; by text message to a predetermined recipient; and/or by email to a predetermined address.

In embodiments of the invention, the message on each of the one or more channels may be a variant of: “Connect to SA #44 with IP Address xxx.xxx.xxx.xxx. Port xx50 HMI, Port xx51 Tablet, Port xx52 for CAM 1, Port xx53 for CAM 2”. In embodiments of the invention, the actual IP address may be, e.g., a static IP address associated with a SIM card installed in the networking device.

Upon entering the actual numbers from the message into appropriate software, the remote user may, e.g., connect to the various components of the system 100. For example, this may in embodiments of the invention to remotely view and control the tablet PC, the HMI, or both. The remote user may also establish, e.g., an audio or video teleconference including the operator of the system 100.

In embodiments of the invention, the tablet PC may include, e.g., software to control an aerial drone (not pictured) and/or receive video from a such a drone in flight. Such video may then be processed (e.g., stored and/or shared locally and/or remotely) as any other video feed accessible by the tablet PC.

The programmable control system in an embodiment of the invention may include, e.g., a GPS system mounted at the top of the mast, e.g., as part of the networking device. This may allow the system 100 to be tracked. For example, an invisible fence can be identified on a remote system monitoring the system 100 so that it will initiate and alarm if the system 100 is moved outside the fenced area. The GPS system may also, in embodiments of the invention, track movements and the path taken by the system 100. For extra security, according to an embodiment of the invention a battery fail-safe system, such that, e.g., if the main 12-volt DC power supply is disconnected or otherwise disabled, the mast-mounted GPS may retain power from, e.g., a small backup battery located inside the GPS.

The discussion so far has emphasized embodiments in which an arm/mast assembly is mounted on a trailer. Other kinds of mounting may be possible, e.g., according to alternative embodiments of the invention.

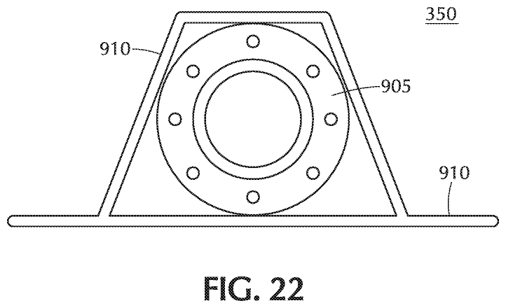

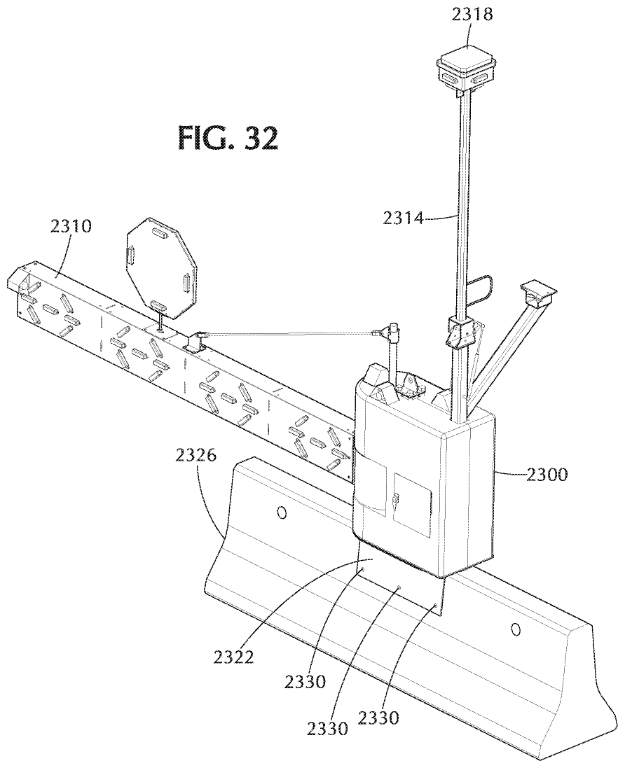

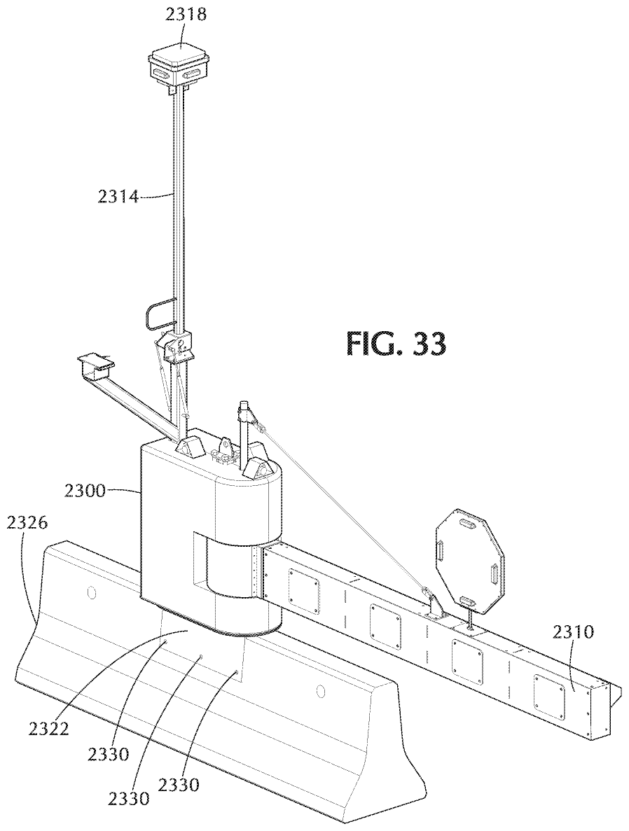

For example, FIGS. 32 and 33 depict in two views an arm/mast assembly 2300 configured to be mountable, e.g., on a structure such as a concrete barrier or roadway divider like a K-rail (also sometimes called a Jersey barrier). As depicted, the arm/mast assembly comprises an electrically operable swing arm 2310 and mast 2314 supporting a mast component enclosure 2318. The capabilities, components, and operation of the arm/mast assembly 2300 may in embodiments of the invention be similar or identical to an arm/mast assembly 110, e.g., as taught in FIGS. 1-26 and accompanying text.

Instead of, e.g., a structural interface trailer mount 405 as FIG. 9 depicts, the apparatus 2300 of FIGS. 32 and 33 may be supported, e.g., by a steel saddle 2322. In embodiments of the invention, the dimensions and shape of the saddle may conform, e.g., to standard dimensions of a K-rail 2326 or other structure (not pictured) to ensure a stable fit. In embodiments of the invention, the fit between the saddle 2322 and the K-rail 2326 may be sufficiently secure that the arm/mast assembly 2322 may be held to the K-rail 2326 solely by the force of gravity and yet operate safely and stably.

In embodiments of the invention, the saddle 2322 may comprise one or more holes 2330. These holes 2330 may be used, e.g., to bolt the saddle 2322 to a K-rail 2326 or other structure to achieve a secure mounting.

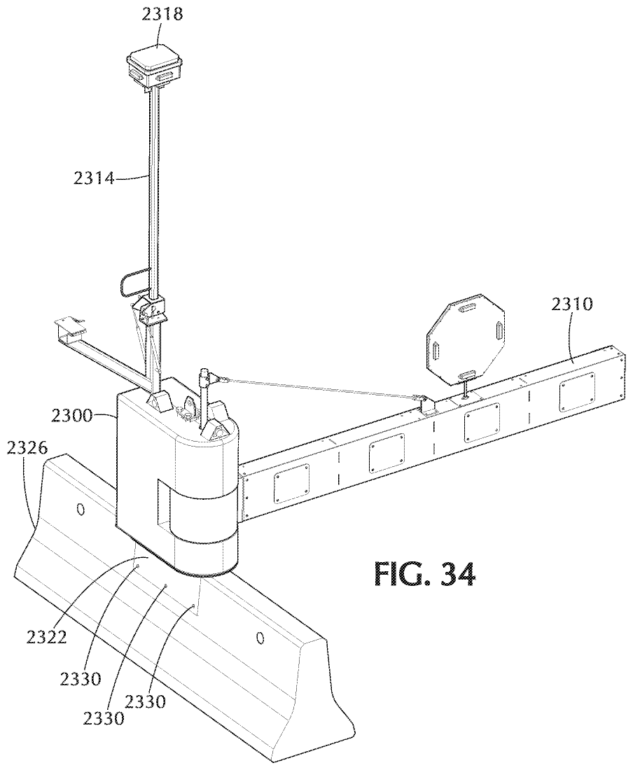

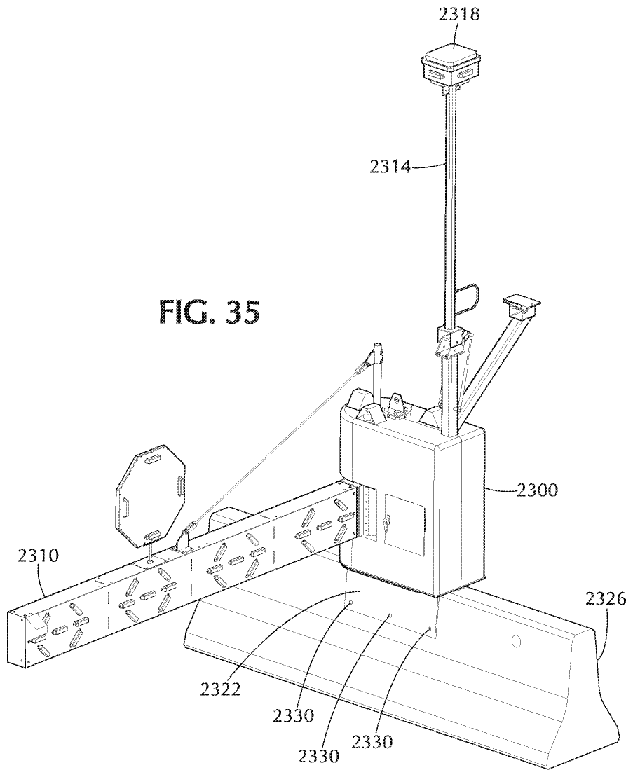

FIGS. 32 and 33 depict an apparatus 2300 with the arm 2310 in an open position, i.e., a position that does not obstruct passing traffic. FIGS. 34 and 35 depict in two views the apparatus 2300 with the arm 2310 in a closed position, i.e., across one or more lanes of traffic.

FIGS. 32-35 do not depict a power supply. It will be appreciated, however, that the apparatus 2300 may be operated, e.g., from any source of 12-volt DC power. For example, an apparatus 2300 according to an embodiment of the invention may be powered, e.g., by batteries and a generator as with the trailer-mounted system taught elsewhere in this disclosure.

FIGS. 32-35 further do not depict a control enclosure or control panel. In embodiments of the invention, the apparatus may be controlled, e.g., via local or remote wireless control, such as may be enabled by a networking device (not pictured) in the mast component enclosure 2318. Such a control may behave similarly or identically to the controls discussed in connection with other embodiments taught herein.

It will be appreciated that a system 100 according to embodiments of the invention provides communication, observation, and collaboration facilities that may be useful also in circumstances where a swing arm and related machinery and traffic control facilities may not be needed. According to embodiments of the invention, a mobile office assembly may be provided that can be used, e.g., to monitor, communicate, and supervise an area.

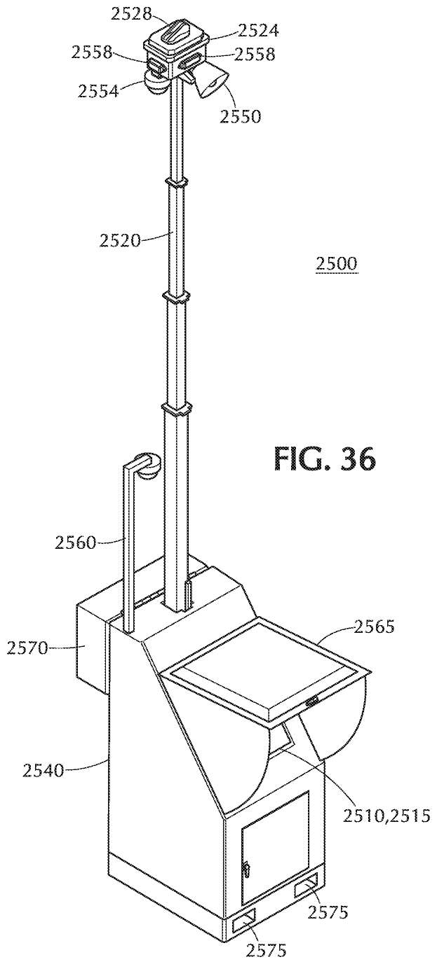

FIG. 36 depicts such a mobile assembly 2500. In an embodiment of the invention, a Public PC may comprise, e.g., an integrated personal computer, itself comprising, e.g., a monitor 2510, a motherboard (not pictured), and a touch screen 2515. A microphone and camera (not pictured) may be provided to support, e.g., real-time video and audio conversations with remote devices.

(The term “personal computer” is used above to identify a particular class of devices and their functioning. According to embodiments of the invention, the assembly 2500 may be used by several people simultaneously, so it may be referred to herein as a “Public PC”.)

The personal computer may be loaded with, e.g., an office suite, engineering software package, and/or other collaboration and/or conferencing tools. The computer may further be loaded with, e.g., software enabling the personal computer to control an aerial drone (not pictured) and/or receive video or other data from one.

According to embodiments of the invention, the assembly 2500 may incorporate a telescopic mast 2520. In an exemplary embodiment of the invention, the 2520 mast may be raised, e.g., by an electrically operated winch (not pictured), to a height of 20 feet. A mast component enclosure 2524 may be mounted to the top of the mast and may contain a networking device (not pictured) such as, e.g., a Sierra Wireless® AirLink® MP70 or AirLink® RV50X. Atop the mast component enclosure 2524, as depicted, is a unit 2528 comprising one or more antennas for, e.g., cellular data and/or Wi-Fi® communication. The mast component enclosure 2524 may be of any suitably durable and weatherproof material such as, e.g., fiberglass.

Also disposed at the top of the mast 2520, according to embodiments of the invention, may be, e.g., a loudspeaker or P.A. horn 2550, an upper camera 2554, and/or one or more lights 2558 (e.g., floodlights and/or a beacon). Cables carrying, e.g., data and power between the mast component enclosure 2524 and the other components may pass, e.g., through the mast 2520 into the body of the assembly 2500. A cable reel (not pictured) may be provided to prevent damage to any cables during raising or lowering of the mast.

It will be appreciated that in embodiments of the invention, a mast component enclosure 2524 may be similar or identical in appearance, configuration, contents, and/or functioning, e.g., to a mast component enclosure 116 (FIGS. 1-3) as described in connection with FIGS. 1-3 and associated embodiments.

Returning to FIG. 36, a lower short mast 2560 may be provided in an embodiment of the invention to support a lower camera 2565, which may, e.g., provide an improved view of the area near the operator's position. In embodiments of the invention, the short mast 2550 may be configured to be raised and lowered manually.

The networking device may establish and/or support a LAN in which various components of the assembly (e.g., the personal computer, the cameras, and an optional printer) participate through wired and/or wireless connections to the LAN. The networking device may act, e.g., as a router between the LAN and a WAN, such as the Internet, accessed via the cellular data network.

Power may be provided, e.g., by one or more 12-volt deep cycle batteries (not pictured). A recharging unit may allow recharging the battery or batteries, e.g., from a 120-volt AC source (not pictured). In an embodiment of the invention a generator and fuel (e.g., one or more propane tanks) may be provided, e.g., separately or integrated into the assembly, as a source of electricity to recharge the batteries.

In an embodiment of the invention, an enclosure 2540 may be formed, e.g., out of sheet metal. As depicted, the enclosure 2540 includes a sun shade 2565 that may be lowered and locked, e.g., to protect the components from weather and/or vandalism. An enclosure according to an embodiment of the invention may be adapted to include, e.g., a printer (not pictured), which may participate in the LAN and thereby be accessible by the Public PC.

The enclosure may similarly in an embodiment of the invention include a locking mast cover 2570 to protect the masts 2520, 2560, when lowered, from, e.g., weather and/or vandalism.

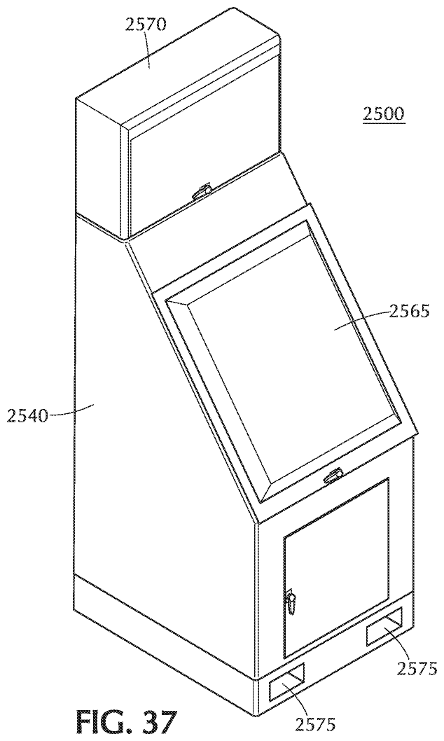

FIG. 37 depicts an assembly 2500 according to an embodiment of the invention with the sunshade 2565 closed, the masts 2520, 2560 lowered, and the mast cover 2570 closed.

Returning to FIG. 36, in an embodiment of the invention, the enclosure may, as depicted, include forklift slots 2575 to support moving the assembly 2500, e.g., over unimproved surfaces such as construction sites. Alternately or in addition, the enclosure may be mounted on casters (not pictured) for transportation on, e.g., roads, walkways, floors, and other smooth, hard surfaces.

1. A trailer-mounted apparatus for controlling the flow of traffic, comprising:
a trailer;
a movable horizontal swing arm, supported by and actuated by an electrically-powered mechanism affixed to the trailer, the arm being configured to have a closed position, in which the horizontal swing arm obstructs the flow of traffic in at least one traffic lane adjacent to the trailer, and an open position in which the horizontal swing arm permits the free flow of traffic in the at least one lane;
a control position comprising at least one control panel for use by an operator to control the arm; and
a power supply configured to provide electric power to the control position and the electrically-powered mechanism.

2. The apparatus of claim 1, comprising:
a programmable control system; and
a vertical mast, the mast supporting a mast component enclosure;
wherein:
the programmable control system is operatively coupled to the control panel;
the mast component enclosure contains at least one set of electrically operable lights and a networking device supporting one or more wireless data networks;
the electrically operable lights and the networking device are operatively connected to the programmable control system; and
the electrically operated lights and the networking device receive electrical power from the power supply.

3. The apparatus of claim 2, wherein the networking device provides one or more wired data networks usable at the apparatus.

4. The apparatus of claim 2, comprising one or more video cameras operably coupled to the programmable control system.

5. The apparatus of claim 4, wherein the control position includes at least one video display device allowing the operator to view video feeds produced by at least one of the cameras.

6. The apparatus of claim 4, comprising a data storage device, wherein:
the programmable control system stores video from at least one of the cameras on the data storage device;
the control position comprises at least one hardware interface operatively connected to the programmable control system, the hardware interface permitting operable connection of a removable storage device to the programmable control system; and
the programmable control system is configured to permit downloading stored video to the data storage device.

7. The apparatus of claim 6, wherein:
the programmable control system is configured at least to
establish a data connection with a remote computer via the networking device, using one of the wireless data networks; and
in response to a request from the remote computer, transfer stored video via the wireless data network to the remote computer.

8. The apparatus of claim 2, wherein the power supply comprises one or more rechargeable 12-volt batteries.

9. The apparatus of claim 8, comprising a generator, wherein:
the generator is configured to recharge the batteries; and
the programmable control system is programmed to detect a charge level of the batteries and to cause the generator to recharge the batteries upon determining that the charge level is below a predetermined threshold.

10. The apparatus of claim 2, wherein:
the horizontal swing arm comprises a plurality of arrays of lights; and
the programmable control system is programmed to cause the lights in the arrays to operate according to a predetermined pattern in response to a command from an operator.

11. The apparatus of claim 10, wherein the programmable control system is configured at least to receive the command via the control panel.

12. The apparatus of claim 10, wherein the programmable control system is configured at least to receive the command via a remote control.

13. The apparatus of claim 10, wherein the programmable control system is configured at least to:
participate in the data network via the networking device; and
receive the command from a remote device via the data network.

14. The apparatus of claim 2, wherein the programmable control system is configured at least to operate the arm in response to a command received from a remote control.

15. The apparatus of claim 2, wherein the programmable control system is configured at least to:
participate in the data network via the networking device; and
receive the command from a remote device via the data network.

16. An apparatus for controlling the flow of traffic, comprising:
a movable horizontal swing arm, supported by and actuated by an electrically-powered mechanism, configured to have a closed position, in which the horizontal swing arm obstructs the flow of traffic in at least one traffic lane adjacent to the apparatus, and an open position in which the horizontal swing arm permits the free flow of traffic in the at least one lane;
a control position comprising at least one control panel for use by an operator to control the arm; and
a power supply configured to provide electric power to the control position and the electrically-powered mechanism.

17. The apparatus of claim 16, comprising a saddle attached to the electrically powered mechanism, the saddle being configured to secure the apparatus to a highway barrier for operation.

18. The apparatus of claim 17, wherein the saddle is configured to be affixed to the highway barrier by one or more straps.

19. The apparatus of claim 18 comprising:
a programmable control system; and
a vertical mast, the mast supporting a mast component enclosure;
wherein:
the programmable control system is operatively coupled to the control panel;
the mast component enclosure contains at least one set of electrically operable lights and a networking device supporting one or more wireless data networks;
the electrically operable lights and the networking device are operatively connected to the programmable control system; and
the electrically operated lights and the networking device receive electrical power from the power supply.

20. The apparatus of claim 19, wherein the networking device provides one or more wired data networks usable at the apparatus.

21. The apparatus of claim 19, comprising one or more video cameras operably coupled to the programmable control system.

22. The apparatus of claim 21, wherein the control position includes at least one video display device allowing the operator to view video feeds produced by at least one of the cameras.

23. The apparatus of claim 21, comprising a data storage device, wherein:
the programmable control system stores video from at least one of the cameras on the data storage device;
the control position comprises at least one hardware interface operatively connected to the programmable control system, the hardware interface permitting operable connection of a removable storage device to the programmable control system; and
the programmable control system is configured to permit downloading stored video to the data storage device.

24. The apparatus of claim 23, wherein:
the programmable control system is configured at least to
establish a data connection with a remote computer via the networking device, using one of the wireless data networks; and
in response to a request from the remote computer, transfer stored video via the wireless data network to the remote computer.

25. The apparatus of claim 19, wherein the power supply comprises one or more rechargeable 12-volt batteries.

26. The apparatus of claim 19, wherein:
the horizontal swing arm comprises a plurality of arrays of lights; and
the programmable control system is programmed to cause the lights in the arrays to operate according to a predetermined pattern in response to a command from an operator.

27. The apparatus of claim 26, wherein the programmable control system is configured at least to receive the command via the control panel.

28. The apparatus of claim 26, wherein the programmable control system is configured at least to receive the command via a remote control.

29. The apparatus of claim 26, wherein the programmable control system is configured at least to:
participate in the data network via the networking device; and
receive the command from a remote device via the data network.

30. The apparatus of claim 19, wherein the programmable control system is configured at least to operate the arm in response to a command received from a remote control.

31. The apparatus of claim 19, wherein the programmable control system is configured at least to:
participate in the data network via the networking device; and
receive the command from a remote device via the data network.
